(19) United States
(12) Patent Application Publication
(10) Pub. No.: US 2007/0004594 A1
(43) Pub. Date: Jan. 4, 2007

(54) Heat-sensitive recording material and heat-sensitive recording method

(75) Inventors: Makoto Ohno, Shizuoka-ken (JP); Hideo Nagasaki, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/477,545

(22) Filed: Jun. 30, 2006

(30) Foreign Application Priority Data
Jun. 30, 2005 (JP) 2005-192558
Mar. 2, 2006 (JP) 2006-055884

(51) Int. Cl. B41M 5/24

(52) U.S. Cl. 503/201

(57) ABSTRACT

The present invention provides a heat-sensitive recording material including at least a heat-sensitive recording layer on a support, wherein the material contains at least a betaine compound represented by the following formula (1) wherein R represents an alkyl group which may have a substituent. The invention alsp provides a heat-sensitive recording material including at least a heat-sensitive recording layer on a support, wherein the material contains at least a betaine compound represented by the following formula (5) wherein n represents an integer of 1 to 24.

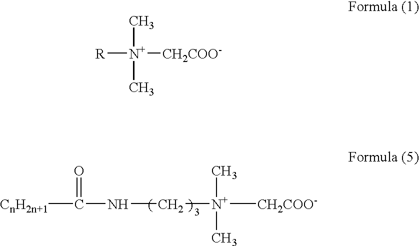

### CROSS-REFERENCE TO RELATED APPLICATION

This application claims priority under 35 USC 119 from Japanese Patent Application Nos. 2005-192558 and 2006-055884, the disclosures of which are incorporated by reference herein.

### BACKGROUND OF THE INVENTION

1. Field of the Invention

The present invention relates to a heat-sensitive recording material and a heat-sensitive recording method, and more particularly to a high image quality heat-sensitive recording material and a heat-sensitive recording method that are suitable for medical recording media.

2. Description of the Related Art

Since a heat-sensitive recording method has the advantages that (1) development is not necessary, (2) when the support is paper, the material quality is similar to that of general paper, (3) handling is easy, (4) the coloring density is high, (5) the recording apparatus is simple, highly reliable, and low cost, (6) noise is low when recording, and (7) maintenance is not necessary, the method has been developed in a variety of fields in recent years. For example, application of a heat-sensitive recording method has been extended to the fields of facsimiles, printers, labels such as POS, and medical images.

In the field of medical images, since a wide dynamic range such as a saturated optical density of about 0.2 to 3.0 or higher is required, the maximum thermal energy given to a heat-sensitive recording material becomes high, and is around 10 times the thermal energy supplied to a general facsimile heat-sensitive paper. For this reason, there is a problem that a thermal head used for recording a medical heat-sensitive recording material is rapidly abraded, and its durability is low.

For prevention of the abrasion of the thermal head, it has been suggested that a layer containing, as a main component, carbon having high hardness and chemical stability is provided on the head surface. Particularly, by increasing the carbon ratio of the uppermost layer of the thermal head, the abrasion resistance of the thermal head can be improved, whereby the life thereof can be extended.

However, a thermal head having a high carbon ratio on the surface has a property that the surface energy is low, and the lubricant contained in the protective layer of the heat-sensitive recording material is difficult to wet when recording. The lubricant contained in the protective layer is added for the purpose of decreasing friction between the thermal head and the heat-sensitive recording material by melting when heating. When a medical image is formed, since recording is performed over a wide energy region, the lubricating property is deficient in some cases in a low energy region or a high energy region. This is presumably because since the surface of the thermal head has a temperature distribution such as a low temperature at a peripheral portion, and a melted lubricant has a characteristic that it is moved to a peripheral portion with low temperature where the surface tension is lowered, the amount of the lubricant present at the head central part having a highest temperature is reduced.

Therefore, it is difficult to exert a sufficient head matching property all over a wide recording energy region, and there is a problem that the recording sound becomes high in a low energy region, and sticking is generated in a high energy region.

A plurality of heat-sensitive recording materials containing a lubricant in a protective layer have been proposed, but these use a polyether-modified silicone oil, an epoxy-modified silicone oil, or alkylsulfonic acid in the protective layer, and are insufficient for imparting properties suitable for a high energy printing part (see, for example, Japanese Patent Application Laid-Open (JP-A) No. 4-39085, JP-A No. 8-90913, JP-A No. 8-230323, and JP-A No. 2000-218943).

On the other hand, a heat-sensitive recording material containing at least three kinds of heat-meltable substances having different melting points in a protective layer has been proposed. At a saturated optical density of less than 3.0, certain results are obtained (see, for example, JP-A No. 2004-299354), and it is desirable that surface roughening is not generated and an image of high quality is obtained even at a high saturated optical density of 3.0 or higher. For this reason, improvement has been tried by increasing the amount of the lubricant in the protective layer, but there are problems that, when the amount of the lubricant is increased, a lubricant which has been melted is crystallized on the surface of the protective layer after recording, the surface is whitened, and a trace of fingerprints is noticeable.

### SUMMARY OF THE INVENTION

The present invention has been made in view of the above circumstances and provides a heat-sensitive recording material and a heat-sensitive recording method.

A first aspect of the invention provides a heat-sensitive recording material comprising at least a heat-sensitive recording layer on a support, wherein the material contains at least a betaine compound represented by the following formula (1): 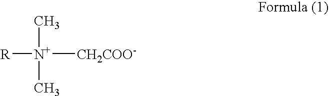
wherein R represents an alkyl group which may have a substituent.

A second aspect of the invention provides a heat-sensitive recording material comprising at least a heat-sensitive recording layer on a support, wherein the material contains a betaine compound represented by the following formula (1), and at least one of a compound represented by the following formula (2) or a compound represented by the following formula (3): 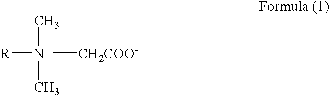
wherein R represents an alkyl group which may have a substituent, 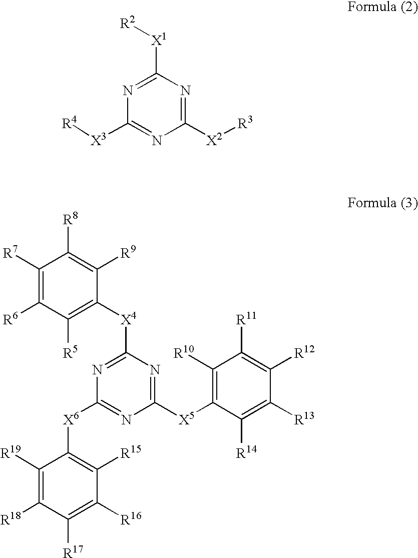
and wherein X¹ to X⁶ each independently represent NR¹, S or O; R¹ represents a hydrogen atom, an alkyl group, an aryl group, an acyl group, an alkoxycarbonyl group, an aryloxycarbonyl group or a carbamoyl group; R², R³ and R⁴ each independently represent a hydrogen atom, an alkyl group or a heterocyclic group and when R¹ and at least two of R², R³ and R⁴ are other than a hydrogen atom, they may be bound to each other to form a ring; and R⁵ to R¹⁹ each independently represent a hydrogen atom, an alkyl group, an aryl group, an alkoxy group, an aryloxy group, an alkylthio group, an arylthio group, an acyloxy group, an acylamino group, an alkoxycarbonyl group, an aryloxycarbonyl group, a carbamoyl group, a sulfamoyl group or a halogen atom and when at least two of R⁵ to R¹⁹ are other than a hydrogen atom, they may be bound to each other to form a ring.

A third aspect of the invention provides a heat-sensitive recording material comprising at least a heat-sensitive recording layer on a support, wherein the material contains at least a betaine compound represented by the following formula (5): 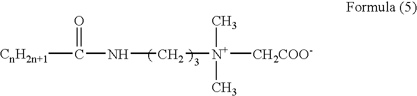
wherein n represents an integer of 1 to 24.

### DETAILED DESCRIPTION OF THE INVENTION

A heat-sensitive recording material of the present invention will be explained in detail below.

<<Heat-Sensitive Recording Material>>

The heat-sensitive recording material of the invention comprises a heat-sensitive recording layer on a support, and preferably further comprises a protective layer, arranged in the order of the heat-sensitive recording layer and the protective layer from the support side. The heat-sensitive recording material of the invention may further comprise other layers, if necessary.

The protective layer is formed on the heat-sensitive recording layer, or when an intermediate layer as the aforementioned other layer is provided on the heat-sensitive recording layer, the protective layer is formed on the intermediate layer. In addition, the protective layer in the invention is preferably an uppermost layer because the effect of the invention becomes more remarkable such that surface roughening and sticking are prevented and the head matching property is excellent all over a wide recording energy region, particularly in a high recording energy region.

(Lubricant)

The heat-sensitive recording material of the invention contains at least a betaine compound represented by the following formula (1) as a lubricant in order to impart a better head matching property over a wide recording energy region.

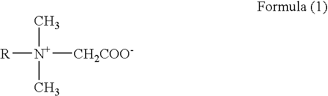

In the formula (1), R represents an alkyl group which may have a substituent. The alkyl group represented by R is preferably an alkyl group having a total carbon number of 1 to 22, and more preferably an alkyl group having a total carbon number of 8 to 20. Examples of the substituent for the alkyl group include CONH—, NHCO—, CO—, COO—, and OCO—.

It is preferable that the betaine compound represented by the formula (1) is a betaine compound represented by the following formula (4).

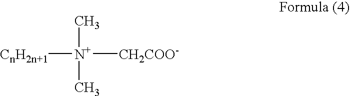

In the formula (4), n represents an integer of 1 to 24, and from the viewpoint of maintenance of the better printing surface state, an integer of 8 to 22 is preferable, and an integer of 12 to 18 is more preferable.

It is preferable that the betaine compound represented by the formula (1) is an amidobetaine compound represented by the following formula (5). And, n in the following formula (5) has the same meaning as that of n in the formula (4), and the preferable range thereof is as in the formula (4).

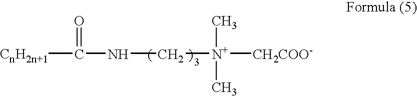

Examples of the betaine compound represented by the formula (1) include, but are not limited to, the following exemplified compound (B-1) to (B-13).

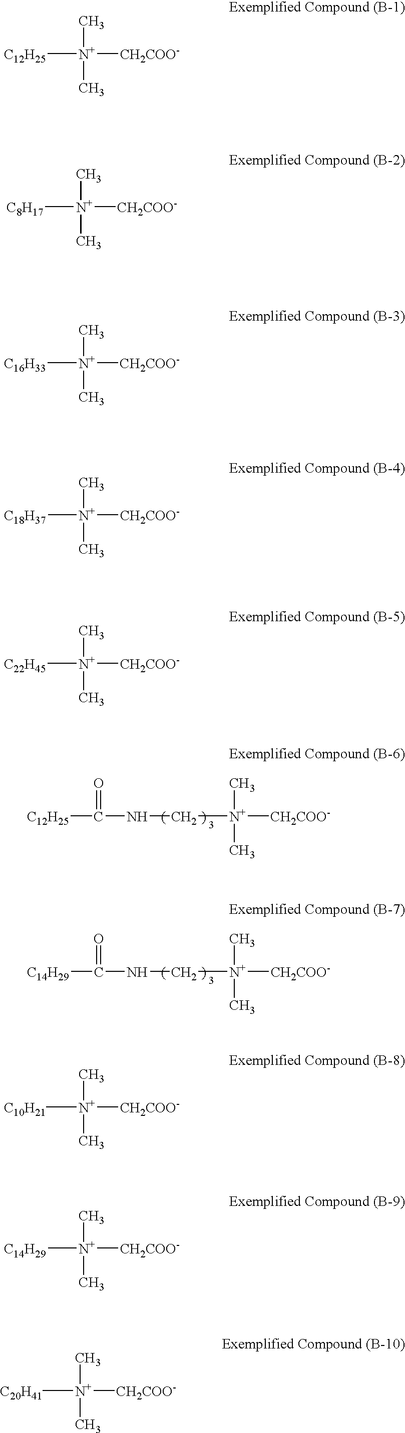

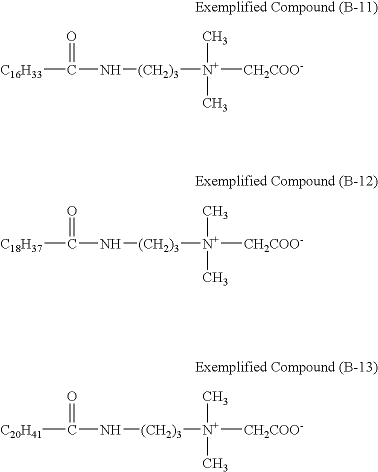

The betaine compound represented by the formula (1) is coated in a range of preferably 0.01 to 0.60 g/m², more preferably 0.02 to 0.30 g/m².

In order to suppress head pollution and improve the transportability, it is preferable that the heat sensitive recording material of the invention further contains a compound represented by the following formula (2) and/or a compound represented by the following formula (3).

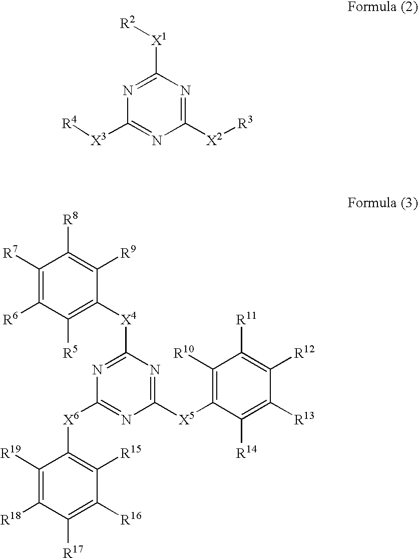

In the formulas (2) and (3), X¹ to X⁶ each independently represent NR¹, S or O. R¹ represents a hydrogen atom, an alkyl group, an aryl group, an acyl group, an alkoxycarbonyl group, an aryloxycarbonyl group or a carbamoyl group. R², R³ and R⁴ each represent independently a hydrogen atom, an alkyl group or a heterocyclic group. When R¹ and at least two of R², R and R4 are other than a hydrogen atom, they may bind to each other to form a ring. R⁵ to R¹⁹ each represent independently a hydrogen atom, an alkyl group, an aryl group, an alkoxy group, an aryloxy group, an alkylthio group, an arylthio group, an acyloxy group, an acylamino group, an alkoxycarbonyl group, an aryloxycarbonyl group, a carbamoyl group, a sulfamoyl group or a halogen atom.

In the formulas (2) and (3), it is preferable that X¹ to X⁶ represent NR¹, S or O. It is preferable that R¹ represents a hydrogen atom, an alkyl group, an aryl group, or an acyl group. When each of R¹, R², R³ and R⁴ are not a hydrogen atom, they may bind to each other to form a ring.

In the formulas (2) and (3), an alkyl group represented by R¹ to R¹⁹ represents a straight or cyclic alkyl group, an alkyl group having a total carbon number of 1 to 30 is preferable, an alkyl group having a total carbon number of 4 to 28 is further preferable, and an alkyl group having a total carbon number of 8 to 26 is particularly preferable. For example, a methyl group, an ethyl group, a normal propyl group, an isopropyl group, a normal butyl group, an isobutyl group, a tertiary butyl group, a normal hexyl group, a normal octyl group, a normal nonyl group, an isononyl group, a tertiary nonyl group, a cyclohexyl group, a decyl group, a dodecyl group, a tetradecyl group, a hexadecyl group, and an octadecyl group are preferable.

In the formulas (2) and (3), an aryl group represented by R¹ and R⁵ to R¹⁹ is preferably an aryl group having a total carbon number of 6 to 30, further preferably an aryl group having a total carbon number of 6 to 26, particularly preferably an aryl group having a total carbon number of 6 to 22. For example, a phenyl group, a naphthyl group, an anthracenyl group, a phenathryl group, a pyrenyl group, and a perylenyl group are preferable.

In the formula (2), as an acyl group represented by R¹, an acyl group having a total carbon number of 2 to 30 is preferable, an acyl group having a total carbon number of 6 to 30 is further preferable, and an acyl group having a total carbon number of 10 to 30 is particularly preferable. For example, an acetyl group, a propanoyl group, a hexanoyl group, an octanoyl group, a decanoyl group, a dodecanoyl group, a tetradecanoyl group, a hexadecanoyl group, an octadecanoyl group, and a benzoyl group are preferable.

In the formula (2), the heterocyclic group represented by R², R³ and R⁴ may be any of a saturated heterocycle and an unsaturated heterocycle, and a 3-membered to 10-membered heterocycle is preferable, a 4-membered to 8-membered heterocycle is further preferable, and a 5-membered to 7-membered heterocycle is particularly preferable. For example, an oxazole ring, a thiazole ring, an imidazole ring, a pyrazole ring, a triazole ring, an isoxazole ring, an isothiazole ring, a furan ring, a thiophene ring, a pyrrole ring, a pyridine ring, a pyrimidine ring, and a triazine ring are preferable, provided that binding does not occur at the heteroatom site in this case. This heterocyclic group may be benzo-fused, and may have a substituent.

In the formula (3), as the alkoxy group represented by R⁵ to R¹⁹, an alkoxy group having a total carbon number of 1 to 30 is preferable, an alkoxy group having a total carbon number of 4 to 28 is further preferable, and an alkoxy group having a total carbon number of 8 to 26 is particularly preferable. For example, a methoxy group, an ethoxy group, a normal propyloxy group, an isopropyloxy group, a normal butyloxy group, a tertiary butyloxy group, a normal hexyloxy group, a normal octyloxy group, a 2-ethylhexyloxy group, a 3,5,5-trimethylhexyloxy group, a normal decyloxy group, a normal dodecyloxy group, a normal tetradecyloxy group, a normal hexadecyloxy group, a normal octadecyloxy group, a cyclohexyloxy group, a benzyloxy group, an a-methylbenzyloxy group, a 4-vinylbenzyloxy group, a 3-vinylbenzyloxy group, an allyloxy group, a 2-methoxyethoxy group, and a 2-ethoxyethoxy group are preferable.

In the formula (3), as the aryloxy group represented by R⁵ to R¹⁹, an aryloxy group having a total carbon number of 6 to 30 is preferable, an aryloxy group having a total carbon number of 6 to 26 is further preferable, and an aryloxy group having a total carbon number of 6 to 22 is particularly preferable. For example, a phenyloxy group, a naphthyloxy group, an anthracenyloxy group, a pyrenyloxy group, a 2-chlorophenyloxy group, a 4-methoxyphenyloxy group, a 4-phenoxyphenyloxy group, a 4-dodecylthiophenyloxy group, and a 4-cyanophenyloxy group are preferable.

In the formula (3), the alkylthio group represented by R⁵ to R¹⁹ represents a straight or cyclic alkylthio group, and an alkylthio group having a total carbon number of 1 to 30 is preferable, an alkylthio group having a total carbon number of 4 to 28 is further preferable, and an alkylthio group having a total carbon number of 8 to 26 is particularly preferable. For example, a methylthio group, an ethylthio group, a normal propylthio group, an isopropylthio group, a normal butylthio group, an isobutylthio group, a tertiary butylthio group, a normal hexylthio group, a normal octylthio group, a normal nonylthio group, a normal decylthio group, a normal dodecylthio group, a normal tetradecylthio group, a normal hexadecylthio group, a normal octadecylthio group, an isononylthio group, a tertiary nonylthio group, a cyclohexylthio group, and an allylthio group are preferable.

In the formula (3), as the arylthio group represented by R⁵ to R¹⁹, an arylthio group having a total carbon number of 6 to 30 is preferable, an arylthio group having a total carbon number of 6 to 26 is further preferable, and an arylthio group having a total carbon number of 6 to 22 is particularly preferable. For example, a phenylthio group, a naphthylthio group, an anthracenylthio group, a phenathrylthio group, a pyrenylthio group, a perylenylthio group, a 2-butoxyphenylthio group, a 2-benzoylaminophenylthio group, and a 3-octyloxyphenylthio group are preferable.

In the formula (3), the acylamino group represented by R⁵ to R¹⁹ may be any of an aliphatic acylamino group and an aromatic acylamino group. An acylamino group having a total carbon number of 2 to 30 is preferable, an acylamino group having a total carbon number of 4 to 28 is further preferable, and an acylamino group having a total carbon number of 8 to 26 is particularly preferable. For example, an acetylamino group, a propionylamino group, a normal octanoylamino group, a normal decanoylamino group, a normal dodecanoylamino group, a normal tetradecanoylamino group, a normal octadecanoylamino group, a benzoyl amino group, a N-phenylacetylamino group, and a N-methylacetylamino group are preferable.

In the formula (3), as the carbamoyl group represented by R¹ and R⁵ to R¹⁹, a carbamoyl group having a total carbon number of 2 to 30 is preferable, a carbamoyl group having a total carbon number of 4 to 28 is further preferable, and a carbamoyl group having a total carbon number of 8 to 26 is particularly preferable. For example, an ethylaminocarbonyl group, a butylaminocarbonyl group, a hexylaminocarbonyl group, an octylaminocarbonyl group, a dodecylaminocarbonyl group, an octadecylaminocarbonyl group, a diethylaminocarbonyl group, a dinormaloctylaminocarbonyl group, a dinormaldodecylaminocarbonyl group, a phenylaminocarbonyl group, and a benzylaminocarbonyl group are preferable.

In the formula (3), the acyloxy group represented by R⁵ to R¹⁹ may be any of an aliphatic acyloxy group and an aromatic acyloxy group, an acyloxy group having a total carbon number of 2 to 30 is preferable, an acyloxy group having a total carbon number of 4 to 28 is further preferable, and an acyloxy group having a total carbon number of 8 to 26 is particularly preferable. For example, an acetyloxy group, a propionyloxy group, a n-octanoyloxy group, a n-decanoyloxy group, a benzoyloxy group, a n-phenylacetyloxy group, and a N-methylacetyloxy group are preferable.

In the formula (3), as the alkoxycarbonyl group represented by R¹ and R¹ to R¹⁹, an alkoxycarbonyl group having a total carbon number of 2 to 30 is preferable, an alkoxycarbonyl group having a total carbon number of 4 to 28 is further preferable, and an alkoxycarbonyl group having a total carbon number of 8 to 26 is particularly preferable. For example, a methyloxycarbonyl group, an ethyloxycarbonyl group, a butyloxycarbonyl group, a 2-ethylhexyloxycarbonyl group, a decyloxycarbonyl group, a dodecyloxycarbonyl group, and an octadecyloxycarbonyl group are preferable.

In the formula (3), as the aryloxycarbonyl group represented by R¹ and R⁵ to R¹⁹, an aryloxycarbonyl group having a total carbon number of 7 to 40 is preferable, an aryloxycarbonyl group having a total carbon number of 7 to 36 is further preferable, and an aryloxycarbonyl group having a total carbon number of 7 to 32 is particularly preferable. For example, a phenyloxycarbonyl group, a naphthyloxycarbonyl group, an anthracenyloxycarbonyl group, and a pyrenyloxycarbonyl group are preferable.

In the formula (3), as the sulfamoyl group represented by R⁵ to R¹⁹, a sulfamoyl group having a total carbon number of 0 to 30 is preferable, a sulfamoyl group having a total carbon number of 6 to 28 is further preferable, and a sulfamoyl group having a total carbon number of 10 to 26 is particularly preferable. For example, unsubstituted sulfamoyl, a N,N-dimethylsulfamoyl group, a N,N-diethylsulfamoyl group, a N,N-dibutylsulfamoyl group, a pyrrolidinosulfonyl group, a piperidinosulfonyl group, a morpholinosulfonyl group, a N′-sulfonylpiperazinosulfonyl group, and a hexamethyleneiminosulfonyl group are preferable.

In the formula (3), as the halogen atom represented by R⁵ to R¹⁹, a fluorine atom, a chlorine atom, a bromine atom, and an iodine atom are preferable, and a fluorine atom and a chlorine atom are particularly preferable.

In the formulas (2) and (3), the substituent represented by R¹ to R¹⁹ may further have a substituent, and as the substituent, for example, an alkyl group, an aryl group, a halogen atom, an alkoxy group, an aryloxy group, an alkylthio group, an arylthio group, an alkoxycarbonyl group, an aryloxycarbonyl group, an alkoxycarbonylamino group, an aryloxycarbonylamino group, an acyloxy group, an acylamino group, a carbamoyl group, a carbamoylamino group, a sulfamoyl group, a sulfamoylamino group, a cyano group, a carboxylic acid group, a sulfonic acid group and a heterocyclic group are preferable.

In the formulas (1) and (2), it is preferable that at least one of X¹ to X³ and at least one of X⁴ to X⁶ are S, O or NH. And, it is preferable that R², R³ and R⁴ are each independently an alkyl group having a total carbon number of 8 or more (more preferably, a total carbon number of 8 to 22). Further, it is preferable that R⁵ to R¹⁹ are each independently a group having a carbon number of 4 or more (more preferably, carbon number of 6 to 22).

From the viewpoint of environmental loading and the cost, it is preferable that X¹-R², X²-R³ and X³-R⁴ in the formula (2) are the same since compound synthesis is easy.

In addition, also in the formula (3), it is preferable based on the same reason that X⁴—Ph—(R⁵)(R⁶)(R⁷)(R⁸)(R⁹), X⁵—Ph—(R¹⁰)(R¹¹)(R¹²)(R¹³)(R¹⁴) and X⁶—Ph—(R¹⁵)(R¹⁶)(R¹⁷)(R¹⁸)(R¹⁹) are the same (wherein Ph represents a benzene ring).

<Synthesis of Compound Represented by the Formula (2) and Compound Represented by the Formula (3)>

Synthesis of a general 1,3,5-triazine compound is described in “Methods of Organic Chemistry 4^{th} edition volume E9c” (authored by E. SCHAUMANN (1998) THIEME STUTTGART) chapter 2.3 (667-796). The synthesis is also described in JP-A No. 2004-331950 in detail. Among them, a method using cyanuric chloride is a comparatively simple method. Synthesis of a triazine compound in the invention can be performed by a substitution reaction of cyanuric chloride with corresponding amine, aniline, thiol or alcohol.

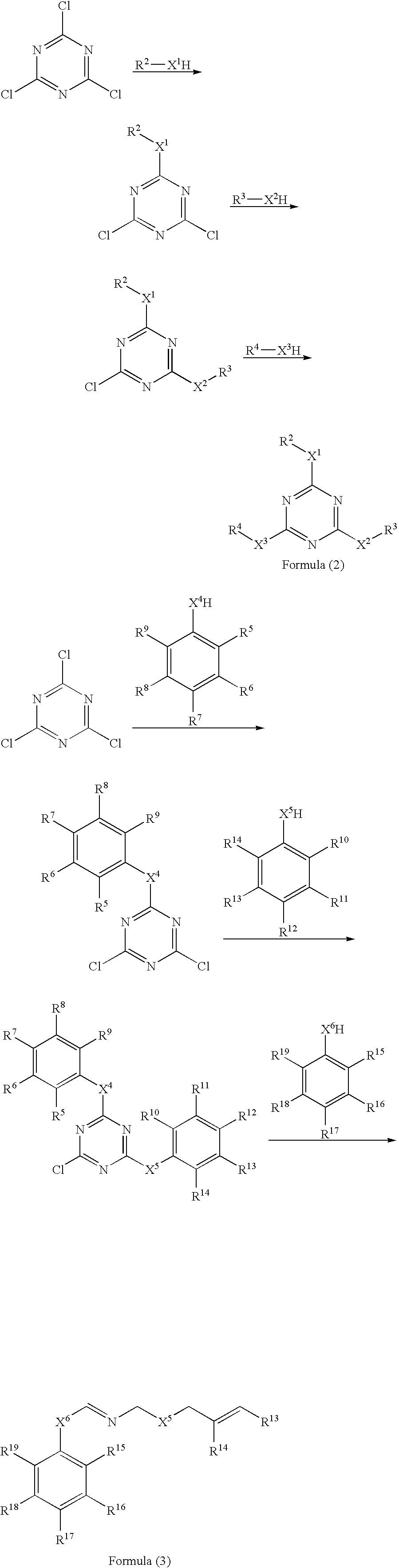

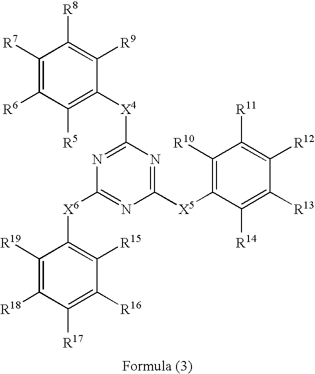

In methods of synthesizing a compound represented by the formula (2) and a compound represented by the formula (3) in the invention, the following condition can be used.

Examples of a solvent used in the reaction include nitrile solvents such as acetonitrile and propionitrile, ester solvents such as ethyl acetate and butyl acetate, ketone solvents such as acetone and methyl ethyl ketone, ether solvents such as diethyl ether, tetrahydrofuran, methyl-t-butyl ether and dioxane, amide solvents such as dimethylformamide and dimethylacetamide, halogenated hydrocarbon solvents such as chloroform, methylene chloride, dichloroethane and chlorobenzene, and sulfolane, dimethyl sulfoxide and water. The amount of the solvent to be used may be such that raw materials are dissolved, and at high concentration, the stirring efficiency is reduced due to high viscosity, and at low concentration, the volumetric efficiency is reduced. The reaction temperature may be selected in a range of −10° C. to 150° C.

As a deoxidizer, a basic compound is used. In this case, the basic compound may be an inorganic base or an organic base, and examples thereof include sodium hydroxide, potassium hydroxide, sodium bicarbonate, sodium carbonate, potassium carbonate, sodium acetate, potassium acetate, triethylamine, and pyridine. The method of isolating the product after completion of the reaction is not particularly limited, and a method of adding water to a reaction system to crystallize the product followed by filtration and washing with water, and a method of adding water to the reaction system, extracting the product with an organic solvent such as ethyl acetate, toluene, diethyl ether, chloroform and methylene chloride, washing this with water, and distilling an organic solvent off are possible. The method of purifying the resulting product is not particularly limited, and purification can be performed by a conventional purifying procedure such as recrystallization, column chromatography, and distillation.

Examples of a compound represented by the formula (2) and a compound represented by the formula (3) (exemplified compounds: A-01 to A-57) will be shown below, but the invention is not limited to them. In the following examples, Me represents a methyl group, Et represents an ethyl group, Bu represents a butyl group, and Ac represents an acetyl group.

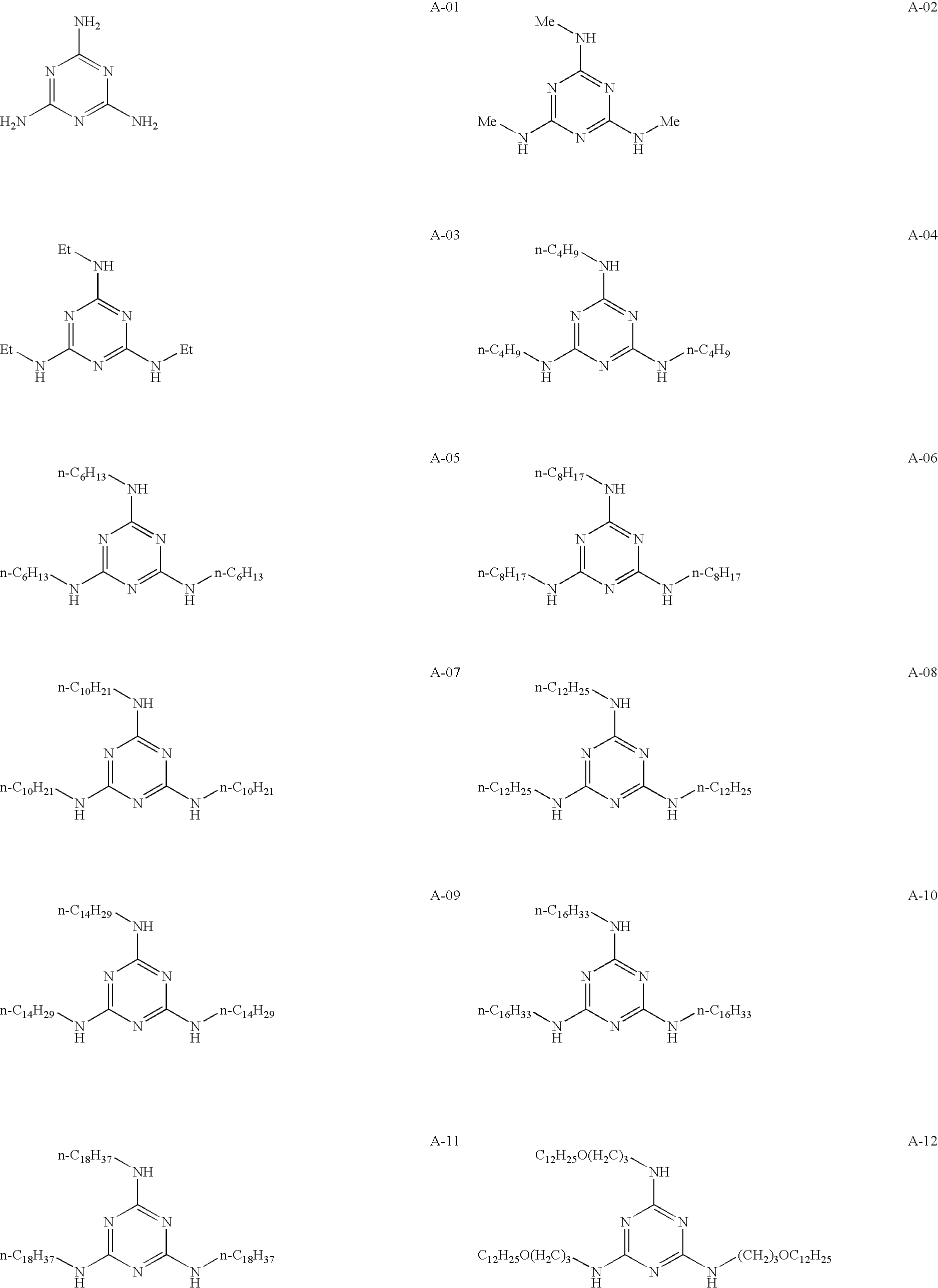

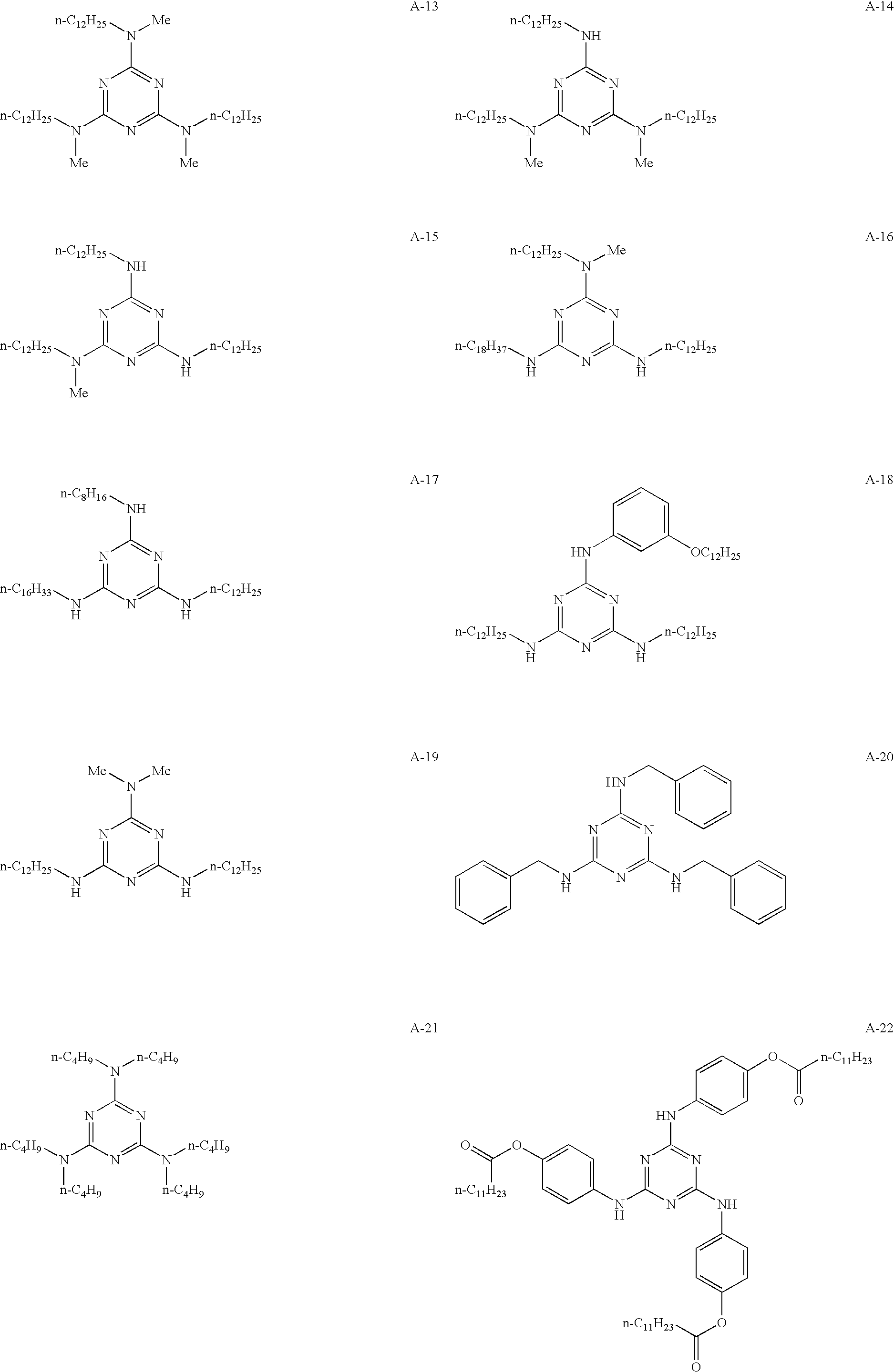

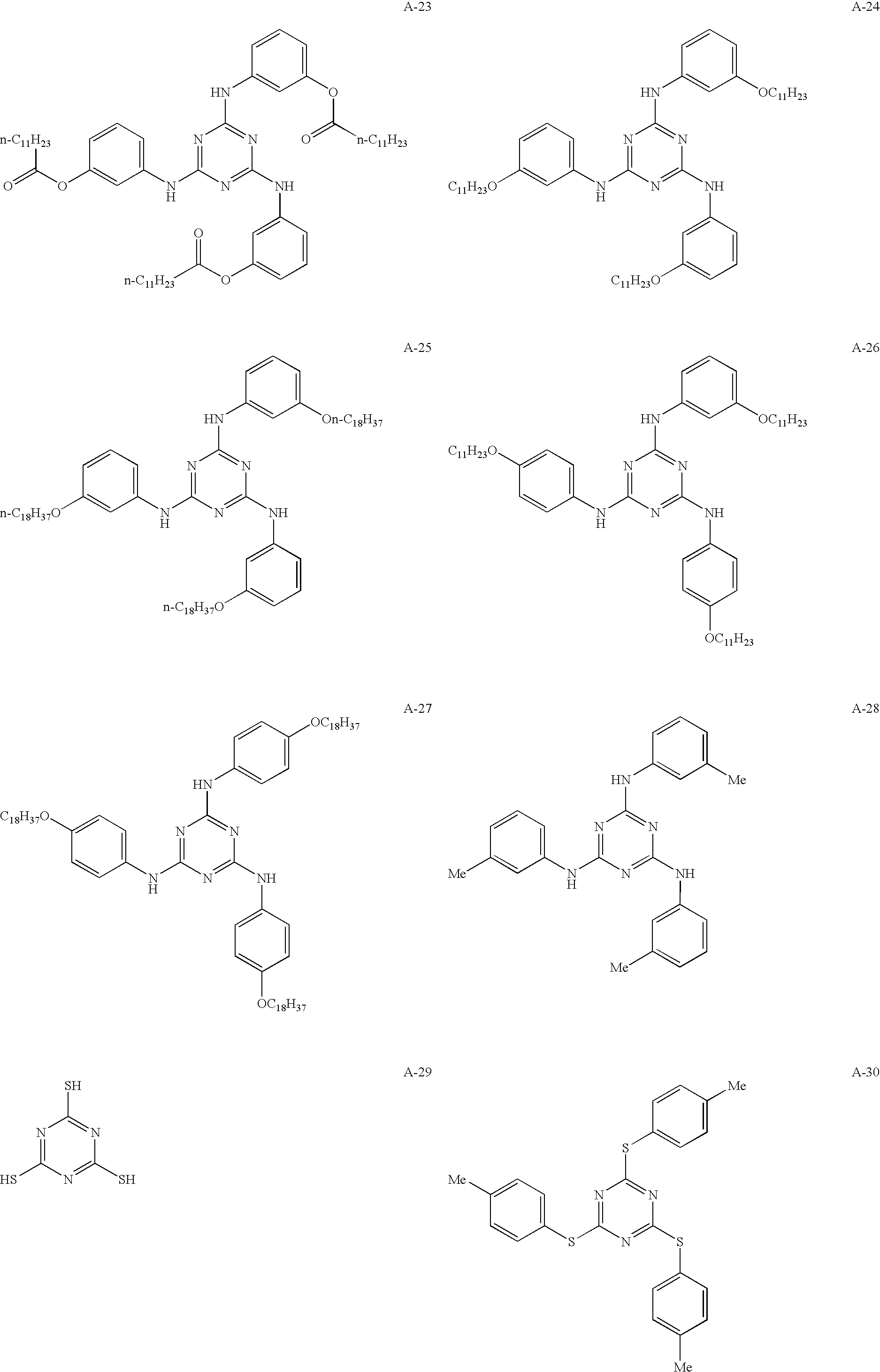

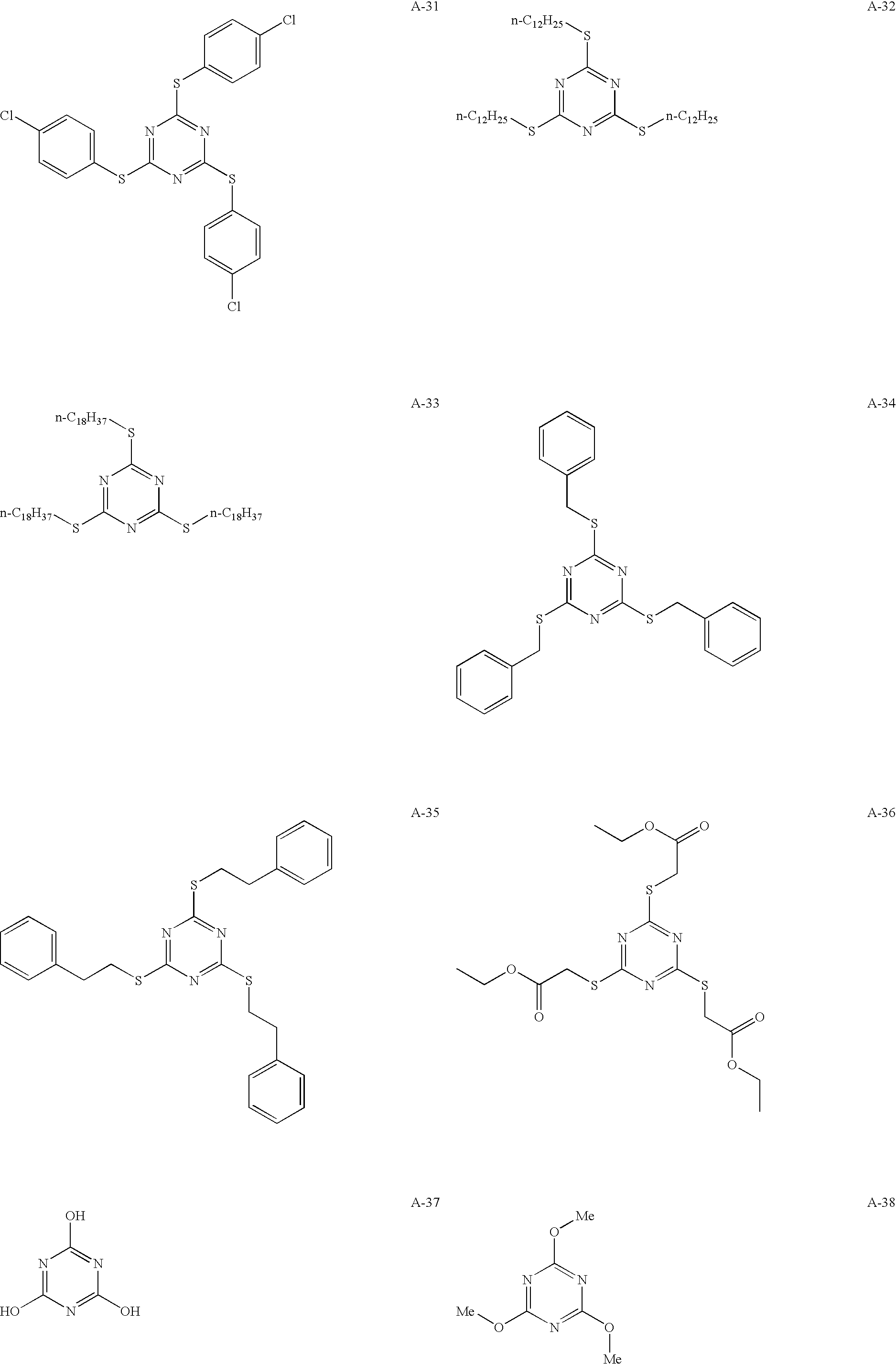

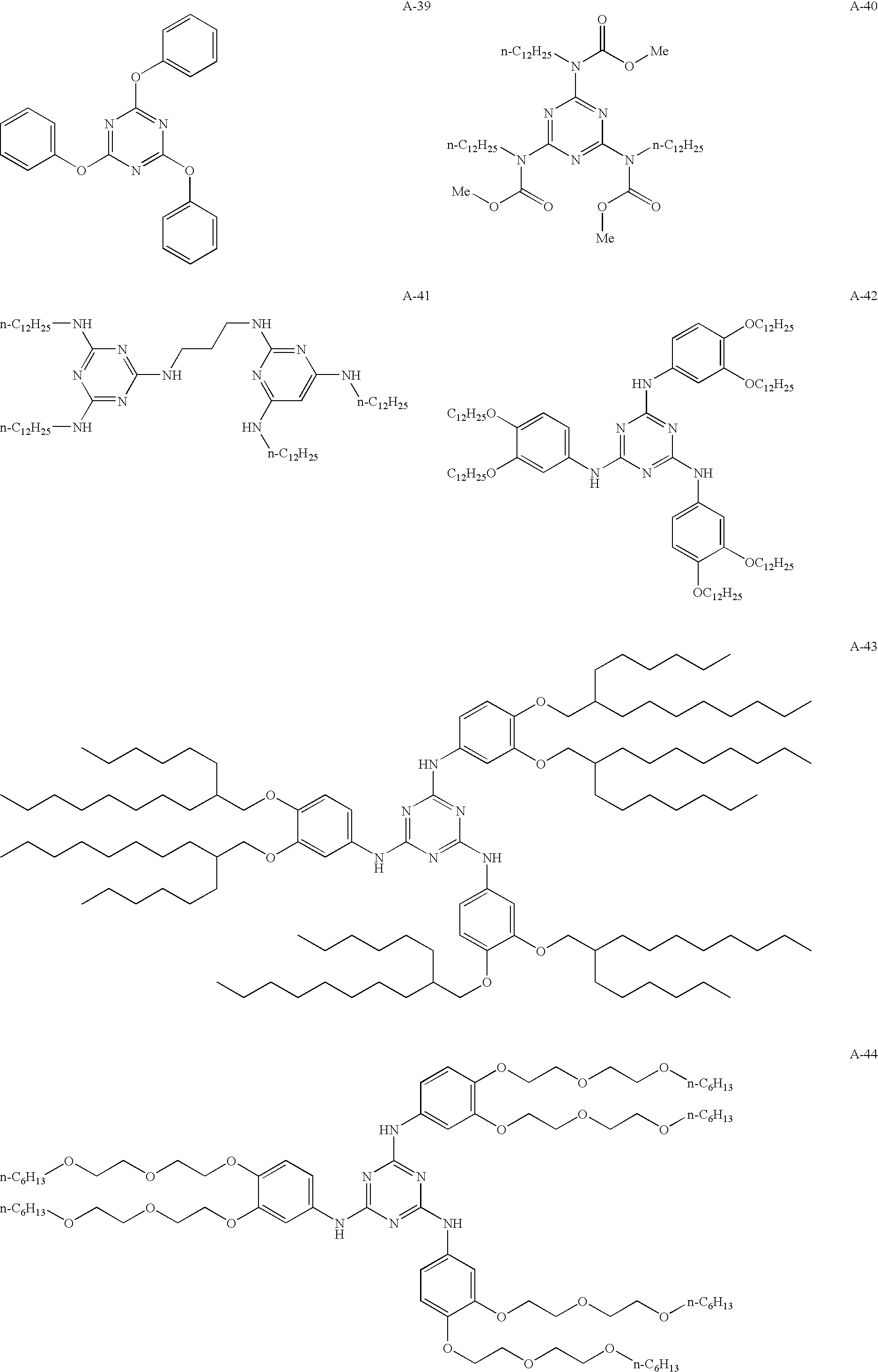

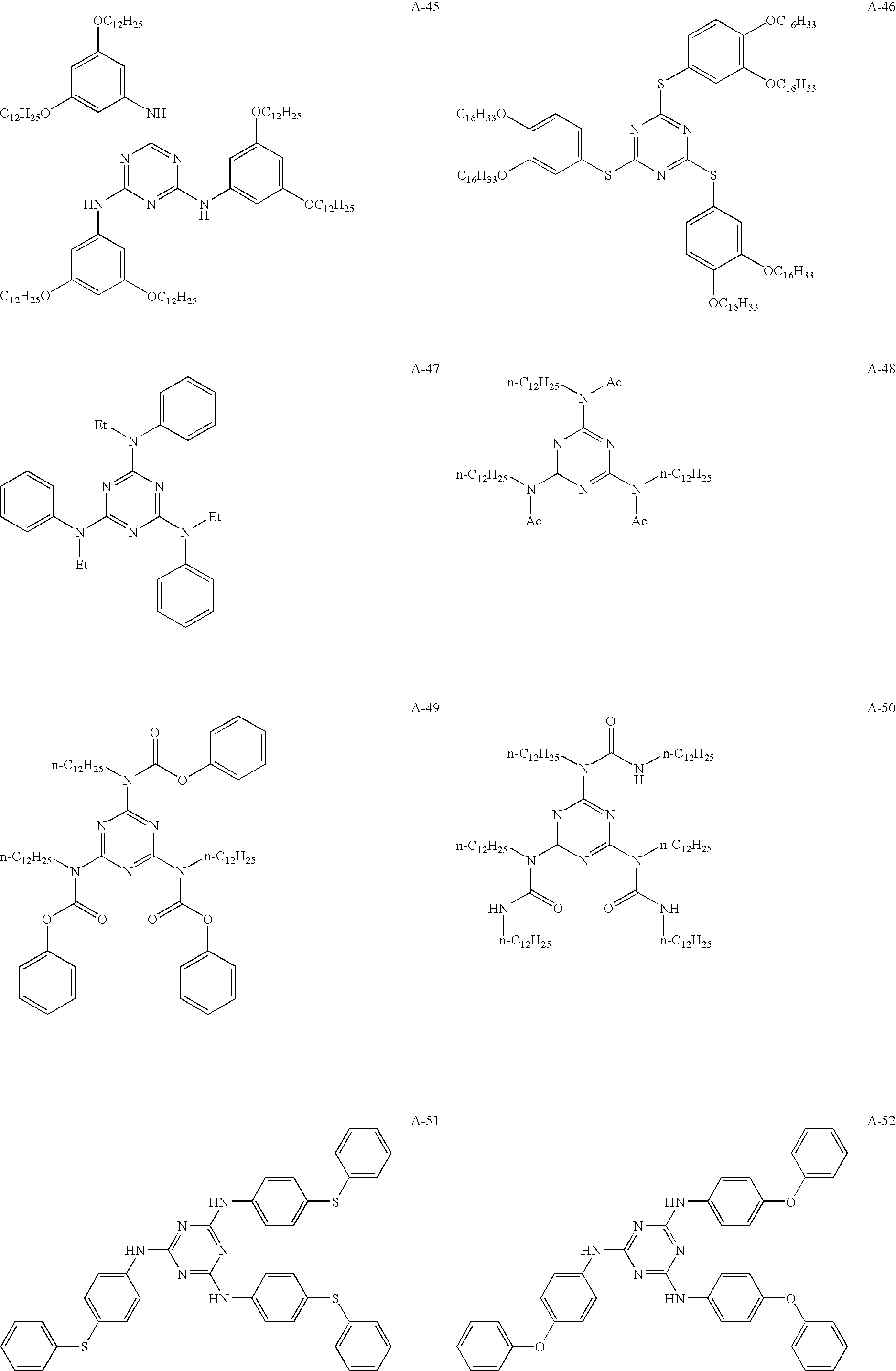

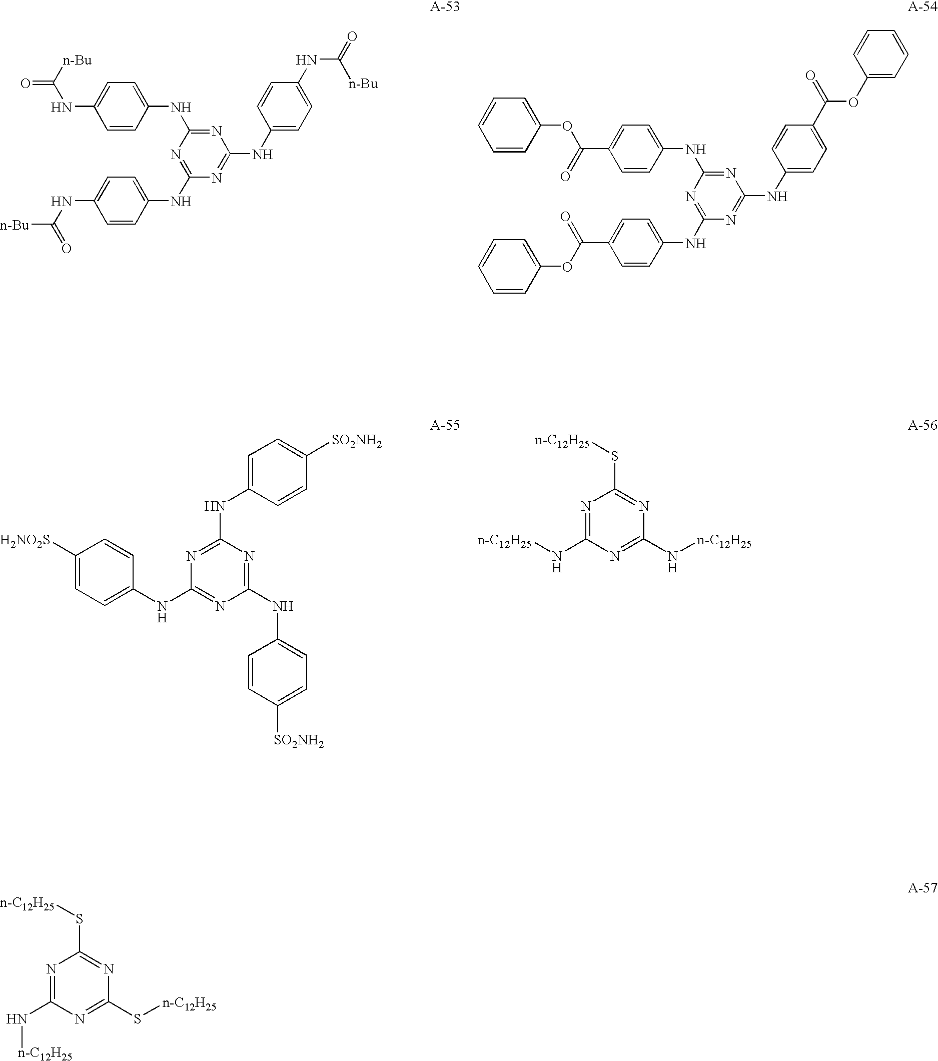

The total amount of the compounds represented by the formula (2) and/or the formula (3), when contained in a protective layer, which is a preferable mode as described later, is preferably in a range of 0.05 to 50% by mass of the total dry coating amount of the protective layer. A more preferable range is 0.5 to 20% by mass, and a further preferable range is 1 to 10% by mass.

By containing the betaine compound represented by the formula (1), the heat-sensitive recording material of the invention can afford the effect that surface roughening and sticking are prevented and head matching property is excellent all over a wide recording energy region, particularly in a high recording energy region. In addition, by further containing the compound represented by the formula (2) and/or the compound represented by the formula (3), the effect of suppressing head pollution and improving the transportability is obtained without deteriorating the aforementioned effect.

In addition, in the heat-sensitive recording material of the invention, it is preferable that the betaine compound represented by the formula (1), and the compound represented by the formula (2) and/or the compound represented by the formula (3) are contained in the same layer because these two effects become remarkable.

In the heat-sensitive recording material of the invention, it is preferable that the layer containing the betaine compound represented by the formula (1) is a protective layer because the effect of preventing surface roughening and sticking and being excellent in the head matching property is sufficiently exerted all over a wide recording energy region, particularly in a high recording energy region.

The layer containing the betaine compound represented by the formula (1) may be a layer other than a protective layer, and when the layer is a color forming layer (heat-sensitive recording layer), the compound becomes a coating assistant, in addition to the aforementioned effect.

On the other hand, in the heat-sensitive recording material of the invention, it is preferable that the layer containing at least one of the compound represented by the formula (2) and the compound represented by the formula (3) is a protective layer because the effect of suppressing head pollution and improving the transportability is sufficiently exerted.

In addition, the layer containing the compound represented by the formula (2) and/or the compound represented by the formula (3) may be a layer other than a protective layer, and for example, when the layer is a color forming layer (heat-sensitive recording layer), the compounds become a discoloration and fading preventing agent, in addition to the aforementioned effect.

The heat-sensitive recording material of the invention is particularly preferably such that the protective layer contains the betaine compound represented by the formula (1), and the compound represented by the formula (2) and/or the compound represented by the formula (3).

It is preferable that the protective layer contains a lubricant which is liquid at ambient temperature, and/or a thermally meltable lubricant. Herein, the “thermally meltable lubricant” refers to a substance which is melted when the heat at ambient temperature (10 to 30° C.) or higher is applied, and preferably a substance which is melted when the heat at 35° C. or higher is applied.

It is more preferable that the protective layer contains at least three kinds of thermally meltable lubricants having different melting points.

When the protective layer contains at least three kinds of thermally meltable lubricants having different melting points, the group of the thermally meltable lubricants having different melting points to be contained in the protective layer is preferably such that each melting point is different from each other by 10° C. or higher, and further preferably such that each melting point is different from each other by 15° C. or higher. In addition, in the group of the thermally meltable lubricants having different melting points, it is preferable that the lubricants do not dissolve with each other. An example in which three kinds of thermally meltable lubricants having different melting points are used will be explained below, but the invention is not limited to this, and four or more kinds of thermally meltable lubricants may be used.

In the case where the protective layer contains at least three kinds of thermally meltable lubricants having different melting points, the group of three kinds of thermally meltable lubricants having different melting points will be explained by roughly classifying into a low melting point thermally meltable lubricant, an intermediate melting point thermally meltable lubricant, and a high melting point thermally meltable lubricant.

As the low melting point thermally meltable lubricant, a lubricant having a melting point of 40 to 70° C. is preferable. Examples of the low melting point thermally meltable lubricant include alkylphosphate ester (melting point 40° C.), paraffin wax (melting point 70° C. or lower), stearic acid (melting point 70° C.), stearic acid monoglyceride (melting point 50° C.), lauric acid, myristic acid, and palmitic acid.

The alkylphosphate ester can be expressed, for example, by the following formula (6).

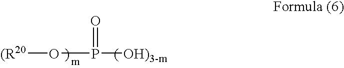

In the formula (6), R²⁰ represents an alkyl group. The alkyl group may be substituted with a substituent. And, m represents 1 or 2.

As the intermediate melting point thermally meltable lubricant, a lubricant having a melting point of 70 to 110° C. is preferable. Examples of the intermediate melting point thermally meltable lubricant include stearic acid amide (melting point 100° C.), methylolstearic acid amide (melting point 101° C.), polyethylene wax (melting point 110° C. or lower), paraffin wax having a melting point of 70 to 90° C. when paraffin wax is not used as the low melting point thermally meltable substance, glycerin tri-12-hydroxystearate, oleic acid amide (melting point 73° C.), zinc oleate (melting point 75° C.), lauric acid amide (melting point 84° C.), aluminum stearate (melting point 102° C.) and manganese stearate (melting point 112° C.).

As the high melting point thermally meltable lubricant, a lubricant having a melting point of 180° C. or lower is preferable, and a lubricant having a melting point of 110° C. to 160° C. is further preferable. When the melting point exceeds 180° C., the lubricating property when recording at high energy is insufficient in some cases. Examples of the high melting point thermally meltable lubricant include zinc stearate (melting point 125° C.), calcium stearate (melting point 160° C.), ethylene bisstearoamide (melting point 140° C.), magnesium stearate (melting point 132° C.), magnesium palmitate (melting point 122° C.), and magnesium myristate (melting point 131° C.).

Examples of the preferable combination of the thermally meltable lubricants include the case where alkylphosphate ester or stearic acid as a low melting point thermally meltable lubricant, stearic acid amide, methylolstearic acid amide or glycerin tri-12-hydroxystearate as an intermediate melting point thermally meltable lubricant, and zinc stearate or ethylene bisstearoamide as a high melting point thermally meltable lubricant are used. In the invention, from the viewpoint of surface whitening and head pollution after recording, it is preferable to use glycerin tri-12-hydroxystearate alone or by mixing as an intermediate melting point thermally meltable substance.

When glycerin tri-12-hydroxystearate is used as an intermediate melting point thermally meltable lubricant, it is preferable to use a thermally meltable lubricant having a melting point of 95° C. or higher and a thermally meltable lubricant having a melting point of 70° C. or lower as the other thermally meltable lubricants having different melting points from the viewpoint that stable head matching suitability can be imparted over a wide energy region.

When three kinds of thermally meltable lubricants having different melting points are used, the mixing ratio of a low melting point thermally meltable lubricant/an intermediate melting point thermally meltable lubricant/a high melting point thermally meltable lubricant is preferably around 1 to 3/1 to 3/1 to 5. In addition, the content of each thermally meltable lubricant in a protective layer is preferably 1 to 50% by mass and further preferably 10 to 30% by mass relative to the total dry coating amount of the protective layer. When the content is less than 5% by mass, the head matching property (stick, sound) in a particular energy region may be deteriorated, and when the content exceeds 50% by mass, head pollution and print image tailing may occur.

The lubricant which is liquid at ambient temperature will be explained. The “lubricant which is liquid at ambient temperature” means a lubricant which is liquid at ambient temperature (10 to 30° C.), examples thereof include a silicone oil, various modified silicone oils, liquid paraffin and mineral oils, and a silicone oil and a modified silicone oil are preferable. The content of the lubricant which is liquid at ambient temperature in a protective layer is preferably 10 to 500 parts by mass and further preferably 50 to 200 parts by mass per 100 parts by mass of the total amount of the thermally meltable lubricants used as the lubricant contained in the protective layer.

A lubricant is added to a protective layer in the form of a dispersion or an emulsion. The lubricant, when it is a solid, 1) is used in the form of a dispersion in water obtained by dispersing the lubricant by a known dispersing apparatus such as a homogenizer, a dissolver and a sand mill in the presence of a dispersing agent such as a water-soluble polymer (such as polyvinyl alcohol) and various surfactants, or 2) is used in the form of an emulsion obtained by dissolving the lubricant in a solvent and emulsifying this by a known emulsifying apparatus such as a homogenizer, a dissolver and a colloid mill in the presence of a dispersing agent such as a water-soluble polymer and various surfactants.

When these lubricants are liquid, they are used in the form of the aforementioned emulsion. The average particle diameter of the dispersion and the emulsion is preferably 0.1 to 5.0 μm and further preferably 0.1 to 2.0 μm. The average particle diameter as used herein refers to a 50% average particle diameter measured at a transmittance of 75±1% by a laser diffraction particle size distribution measuring apparatus LA-700 manufactured by Horiba, Ltd.

The method of adding the betaine compound represented by the formula (1), the compound represented by the formula (2) and the compound represented by the formula (3) is not particularly limited, and they may be added by dissolving in a polar solvent such as water and methanol, or may be added by emulsifying or dispersing like the above lubricant, depending on the solubility. (Pigment) It is preferable that the protective layer of the heat-sensitive recording material of the invention contains a pigment. A pigment is used normally for the purpose of rendering recording by a thermal head suitable. That is, a pigment is used for suppressing generation of sticking and an unusual sound. It is preferable that organic and/or inorganic pigments are used.

As a pigment which can be used in the protective layer, a pigment having an average particle diameter, more particularly, a 50% volume average particle diameter (an average particle diameter of a pigment particle corresponding to 50% volume in a pigment measured by a laser diffraction/scattering particle size distribution measuring apparatus LA7000 (manufactured by Horiba, Ltd.); hereinafter, simply referred to as “average particle diameter” in some cases) as measured by a laser diffraction/scattering method, of 0.10 to 5 μm is preferable, and from the viewpoint that generation of sticking and an unusual sound between a thermal head and a heat-sensitive recording material when recording by the thermal head is prevented, it is more preferable that the 50% volume average particle diameter is in a range of 0.20 to 0.50 μm.

When this 50% volume average particle diameter is in a range of 0.10 to 5.0 μm, the effect of reducing friction against a thermal head is great, and as a result, adhesion of a thermal head and a protective layer of a heat-sensitive recording material when printing, so-called “sticking”, can be effectively prevented.

A pigment which can be used in the protective layer is not particularly limited, examples thereof include known organic and inorganic pigments, and particularly, inorganic pigments such as calcium carbonate, titanium oxide, kaolin, aluminum hydroxide, amorphous silica and zinc oxide, and organic pigments such as urea formalin resin and epoxy resin are preferable. Among them, kaolin, aluminum hydroxide and amorphous silica are more preferable. These pigments may be used alone, or two or more kinds of them may be used in combination.

Among them, the surface thereof may be covered with one or more kinds selected from the group consisting of higher fatty acids, metal salts of higher fatty acids and higher alcohols.

Examples of the higher fatty acid include stearic acid, palmitic acid, myristic acid, and lauric acid.

It is preferable that these pigments are used after dispersing to the aforementioned average particle diameter by a known dispersing apparatus such as a dissolver, a sand mill and a ball mill in the presence of a dispersing aid such as sodium hexametaphosphate, partially saponified or completely saponified polyvinyl alcohol, a polyacrylic acid copolymer and various surfactants (preferably, partially or completely saponified modified polyvinyl alcohol and a polyacrylic acid copolymer ammonium salt). That is, it is preferable to use a pigment after the pigment is dispersed until the 50% volume average particle diameter thereof becomes a particle diameter in a range of 0.1 to 5.0 μm.

From the viewpoint of better transparency, it is preferable that the protective layer contains a water-soluble resin, and from the viewpoint of imparting printing suitability and water resistance, it is more preferable that the protective layer further contains a crosslinking agent which crosslinks the water-soluble resin.

Examples of the water-soluble resin include polyvinyl alcohol, cellulose, gelatin, polyvinylpyrrolidone, sodium alginate, modified starch, gum arabic, casein, a vinyl acetate-acrylamide copolymer and a hydrolysate of a styrene-maleic acid copolymer, and inter alia, polyvinyl alcohol, gelatin and cellulose are preferable.

Examples of the crosslinking agent include a boron compound such as boric acid and borax, a vinylsulfone compound, an aldehyde compound, an epoxy compound, a methylol compound, methylated melamine, an oxazine compound, a triazine compound, polyfunctional isocyanate, a water-soluble zirconium compound and a titanium compound, and inter alia, boric acid, an aldehyde compound, a vinylsulfone compound and a water-soluble zirconium compound are preferable.

The content of the water-soluble resin in a protective layer is preferably 10 to 80% by mass, further preferably 15 to 50% by mass relative to the total dry coating amount of the protective layer, from the viewpoint of transparency and conveying torque.

In addition, the content of the crosslinking agent with respect to 100 parts by mass of the water-soluble resin is preferably 5 to 60 parts by mass, further preferably 10 to 50 parts by mass, from the viewpoint of film hardness.

(Other Components)

A known hardener may be contained in the protective layer.

In addition, in order to uniformly form a protective layer on the heat-sensitive recording layer or on the intermediate layer, it is preferable to add a surfactant to a protective layer-forming coating solution. Examples of the surfactant include a sulfosuccinic acid type alkali metal salt, a fluorine-containing surfactant and acetylene glycols, and specifically, a potassium, sodium or ammonium salt of di-(2-ethylhexyl)sulfosuccinic acid or di-(n-hexyl)sulfosuccinic acid, and acetylene glycols.

Further, for the purpose of prevention of static charge of a heat-sensitive recording material, a surfactant, metal oxide fine particles, an inorganic electrolyte and a polymer electrolyte may be added to the protective layer.

The protective layer may be of a single layer structure or a multi-layer structure of two or more layers. The dry coating amount of the protective layer is preferably 0.2 to 7 g/m², more preferably 1 to 4 g/m².

<Heat-Sensitive Recording Layer>

The heat-sensitive recording layer contains at least a color forming component, and further contains other components if necessary.

(Color Forming Component)

The heat-sensitive recording layer to be used may have any composition as far as it has excellent transparency when untreated and has a nature of forming a color by heating..

Examples of such heat-sensitive recording layer include a so-called 2 component-type heat-sensitive recording layer containing a substantially colorless color forming component A and a substantially colorless color forming component B which forms a color by reacting with the color forming component A, and it is preferable that a color forming component A or a color forming component B is encapsulated in microcapsules. Examples of a combination of two components constituting this 2 component-type heat-sensitive recording layer include the following (a) to (m).

(a) A combination of an electron donating dye precursor and an electron accepting compound,

(b) A combination of a photodegradable diazo compound and a coupler,

(c) A combination of an organic silver salt such as silver behenate and silver stearate, and a reducing agent such as protocatechinic acid, spiroindane and hydroquinone,

(d) A combination of a long chain aliphatic salt such as ferric stearate and ferric myristate, and a phenol such as gallic acid and ammonium salicylate,

(e) A combination of an organic acid heavy metal salt such as a salt of acetic acid, stearic acid or palmitic acid and nickel, cobalt, lead, copper, iron, mercury or silver, and an alkaline earth metal sulfide such as calcium sulfide, strontium sulfide and potassium sulfide, or a combination of the aforementioned organic acid heavy metal salt and an organic chelating agent such as s-diphenylcarbazide and diphenylcarbazone,

(f) A combination of (heavy) metal sulfide such as silver sulfide, lead sulfide, mercury sulfide and sodium sulfide, and a sulfur compound such as Na-tetrathionate, sodium thiosulfate and thiourea,

(g) A combination of aliphatic ferric salt such as ferric stearate, and an aromatic polyhydroxy compound such as 3,4-dihydroxytetraphenylmethane,

(h) A combination of an organic noble metal salt such as silver oxalate and mercury oxalate, and an organic polyhydroxy compound such as polyhydroxyalcohol, glycerin and glycol,

(i) A combination of an aliphatic ferric salt such as ferric pelargonate and ferric laurate, and thiocecylcarbamide or isothiocecylcarbamide derivative,

(j) A combination of an organic acid lead salt such as lead caproate, lead pelargonate and lead behenate, and a thiourea derivative such as ethylenethiourea and N-dodecylthiourea,

(k) A combination of a higher fatty acid heavy metal salt such as ferric stearate and copper stearate, and zinc dialkyldithiocarbamate,

(l) A combination which forms an oxazine dye, such as a combination of resorcine and a nitroso compound,

(m) A combination of a formazan compound, and a reducing agent and/or a metal salt.

Among them, in the heat-sensitive recording material of the invention, it is preferable to use (a) a combination of an electron donating dye precursor and an electron accepting compound, (b) a combination of a photodegradable diazo compound and a coupler, or (c) a combination of an organic metal salt and a reducing agent, and particularly, the combination of (a) or (b) is more preferable.

In addition, the heat-sensitive recording material of the invention can afford an image excellent in transparency by constituting a heat-sensitive recording layer so as to reduce the haze value calculated from (diffuse transmittance/total light transmittance)×100 (%). This haze value is an index expressing transparency of a material, and is generally calculated from a total light transmittance, a diffuse transmission light amount and a parallel transmission light amount by using a hazemeter.

In the invention, examples of the method of reducing the haze value include a method in which the 50% volume average particle diameter of both the color forming components A and B contained in the heat-sensitive recording layer is 1.0 μm or smaller, preferably 0.6 μm or smaller, and a binder is contained in a range of 30 to 60% by mass of the total solid matter of the heat-sensitive recording layer, and a method of microcapsulating any one component of the color forming components A and B, and using the other component, for example, as an emulsion, such that a substantially continuous layer is formed after coating and drying.

In addition, a method in which the refractive indices of components used for a heat-sensitive recording layer become as constant as possible is also effective.

Then, the combinations (a), (b) and (c) which is preferably used in the heat-sensitive recording layer will be explained in detail below.

First, (a) a combination of an electron donating dye precursor and an electron accepting compound will be explained.

The electron donating dye precursor which is preferably used in the invention is not particularly limited as far as it is substantially colorless. The precursor has a nature of donating an electron or accepting a proton such as an acid to form a color, and particularly, has a partial skeleton such as lactone, lactam, sultone, spiropyran, ester and amide, and the precursor is preferably a colorless compound in which the partial skeleton is ring-opened or cleaved when contacted with an electron accepting compound.

Examples of the electron donating dye precursor include a triphenylmethanephthalide compound, a fluoran compound, a phenothiazine compound, an indolylphthalide compound, a leucoauramine compound, a rhodaminelactam compound, a triphenylmethane compound, a triazene compound, a spiropyran compound, a fluorene compound, a pyridine compound, and a piperazine compound.

Examples of the phthalide compound include compounds described in U.S. Reissued Patent No. 23,024, U.S. Pat. No. 3,491,111, U.S. Pat. No. 3,491,112, U.S. Pat. No. 3,491,116, and U.S. Pat. No. 3,509,174.

Examples of the fluoran include compounds described in U.S. Pat. No. 3,624,107, U.S. Pat. No. 3,627,787, U.S. Pat. No. 3,641,011, U.S. Pat. No. 3,462,828, U.S. Pat. No. 3,681,390, U.S. Pat. No. 3,920,510, and U.S. Pat. No. 3,959,571.

Examples of the spiropyran include compounds described in U.S. Pat. No. 3,971,808.

Examples of the pyridine and piperazine compounds include compounds described in U.S. Pat. No. 3,775,424, U.S. Pat. No. 3,853,869, and U.S. Pat. No. 4,246,318.

Examples of the fluorene compound include compounds described in Japanese Patent Application No. 61-240989.

Among them, particularly, preferable examples include 2-arylamino-3-[H, halogen, alkyl or alkoxy-6-substituted aminofluoran] which forms black.

Specific examples thereof include 2-anilino-3-methyl-6-diethylaminofluoran,
2-anilino-3-methyl-6-N-cyclohexyl-N-methylaminofluoran,
2-p-chloroanilino-3-methyl-6-dibutylaminofluoran, 2-anilino-3-methyl-6-dioctylaminofluoran,
2-anilino-3-chloro-6-diethylaminofluoran,
2-anilino-3-methyl-6-N-ethyl-N-isoamylaminofluoran,
2-anilino-3-methyl-6-N-ethyl-N-dodecylaminofluoran,
2-anilino-3-methoxy-6-dibutylaminofluoran, 2-o-chloroanilino-6-dibutylaminofluoran,
2-p-chloroanilino-3-ethyl-6-N-ethyl-N-isoamylaminofluoran,
2-o-chloroanilino-6-p-butylanilinofluoran, 2-anilino-3-pentadecyl-6-diethylaminofluoran,
2-anilino-3-ethyl-6-dibutylaminofluoran, 2-o-toluidino-3-methyl-6-diisopropylaminofluoran,
2-anilino-3-methyl-6-N-isobutyl-N-ethylaminofluoran,
2-anilino-3-methyl-6-N-ethyl-N-tetrahydrofurfurylaminofluoran,
2-anilino-3-chloro-6-N-ethyl-N-isoamylaminofluoran,
2-anilino-3-methyl-6-N-methyl-N-γ-ethoxypropylaminofluoran,
2-anilino-3-methyl-6-N-ethyl-N-γ-ethoxypropylaminofluoran,
2-anilino-3-methyl-6-N-ethyl-N-γ-propoxypropylaminofluoran,
3-phenyl-3′-6′-di-n-hexyloxy-spiro[2,4-benzoxazone-1(1H)9′-(9H)xanthene].

Examples of the electron accepting compound which acts on the electron donating dye precursor include acidic substances such as a phenol compound, an organic acid or a metal salt thereof, and oxybenzoic acid ester, and for example, compounds described in JP-A No. 61-291183.

Specific examples thereof include bisphenols such as
2,2-bis(4′-hydroxyphenyl)propane (general name: bisphenol A),
2,2-bis(4′-hydroxyphenyl)pentane, 2,2-bis(4′-hydroxy-3′,5′-dichlorophenyl)propane,
1,1-bis(4′-hydroxyphenyl)cyclohexane, 1,1-bis(4′-hydroxyphenyl)propane,
1,1-bis(4′-hydroxyphenyl)butane, 1,1-bis(4′-hydroxyphenyl)pentane,
1,1-bis(4′-hydroxyphenyl)hexane, 1,1-bis(4′-hydroxyphenyl)pentane,
1,1-bis(4-hydroxyphenyl)heptane, 1,1-bis(4′-hydroxyphenyl)pentane,
1,1-bis(4′-hydroxyphenyl)octane, 1,1-bis(4′-hydroxyphenyl)dodecane,
1,1-bis(4′-hydroxyphenyl)2-methylpentane, 1,1-bis(4′-hydroxyphenyl)-2-methyl-hexane,
1,4-bis(p-hydroxyphenylcumyl)benzene, 1,3-bis(hydroxyphenylcumyl)benzene,
bis(3-allyl-4-hydroxyphenyl)sulfone, bis(p-hydroxyphenyl)acetic acid benzyl ester,
triethylene glycol-bis[3,(3-tert-butyl-5-methyl-4-hydroxyphenyl)propionate],
n-octadecyl-3-(3,5-di-tert-butyl-4-hydroxyphenyl)propionate,
2,2′-methylene-bis-(4-ethyl-6-tert-butylphenol), 4,4′-thiobis-(3-methyl-6-tert-butylphenol),
2,2′-methylene-bis(4-methyl-6-tert-butylphenol).

Also, salicylic acid derivatives such as 3,5-di-(α-methylbenzyl)salicylic acid,
3,5-di-(tert-butyl)salicylic acid, 3-α-α-dimethylbenzylsalicylic acid and
4-(β-p-methoxyphenoxyethoxy)salicylic acid, and polyvalent metal salts thereof (particularly, zinc and aluminum are preferable) are exemplified.

Also, oxybenzoic acid esters such as benzyl p-hydroxybenzoate, 2-ethylhexyl p-hydroxybenzoate and β-resorcylic acid-2-phenoxyethane, and phenols such as p-phenylphenol, 3,5-diphenylphenol, cumylphenol and 4-hydroxy-4-isopropoxy-diphenylsulfone are exemplified.

Inter alia, from the viewpoint of obtaining better color forming properties, bisphenols and salicylic acid derivative zinc salts are.,particularly preferable.

The electron accepting compounds may be used alone, or two or more kinds thereof may be used in combination.

Then, (b) a combination of a photodegradable diazo compound and a coupler will be explained.

The photodegradable diazo compound is a photodegradable diazo compound which coupling-reacts with a coupler that is a coupling component described later to form a color in a desired hue, and is degraded when subjected to light of a particular wavelength region before forming a color and becomes to have no color forming ability even when a coupling component is present.

The hue in this color forming system is determined by a diazo dye produced by the reaction of a photodegradable diazo compound and a coupler. Therefore, by changing the chemical structure of the diazo compound or the coupler, the hue to be formed can be easily changed, and an intended hue can be obtained depending on the combination of them.

Examples of a photodegradable diazo compound which is preferably used in the present invention include an aromatic diazo compound, and specifically, an aromatic diazonium salt, a diazosulfonate compound and a diazoamino compound.

Examples of the aromatic diazo compound include, but are not limited to, compounds represented by the following formula. As the aromatic diazo compound, an aromatic diazo compound which is excellent in light fixability, produces little colored stain after fixation, and is stable in a color forming part is preferably used.
Aᵣ—N₂⁺X⁻

In the above formula, Aᵣ represents an aromatic hydrocarbon ring group which has a substituent or is unsubstituted, N₂⁺ represents a diazonium group, and X⁻ represents an acid anion.

As the diazosulfonate compound, many compounds have been known in recent years, and they are obtained by treating various diazonium salts with sulfurous acid, and can be suitably used in the heat-sensitive recording material of the invention.

The diazoamino compound can be obtained by coupling a diazo group with dicyandiamide, sarcosine, methyltaurine, N-ethylanthranic acid-5-sulfonic acid, monoethanolamine, diethanolamine or guanidine, and can be suitably used in the heat-sensitive recording material of the invention.

Details of these diazo compounds are described, for example, in JP-A No. 2-136286 in detail.

On the other hand, examples of the coupler which coupling-reacts with the diazo compound include couplers described in JP-A No. 62-146678 including resorcine in addition to 2-hydroxy-3-naphthoic acid anilide.

When a combination of a diazo compound and a coupler is used in the heat-sensitive recording layer, from the viewpoint that the coupling reaction can be more promoted by performing the reaction under basic condition, a basic substance may be added as a sensitizer.

Examples of the basic compound include a basic substance which is insoluble or hardly soluble in water, and a substance which produces an alkali by heating, such as nitrogen-containing compounds such as an inorganic or organic ammonium salt, organic amine, amide, urea and thiourea or a derivative thereof, thioazoles, pyrroles, pyrimidines, piperazines, guanidines, indoles, imidazoles, imidazolines, triazoles, morpholines, piperidines, amidines, formazines and pyridines.

Examples of them include substances described in JP-A No. 61-291183.

Then, (c) a combination of an organic metal salt and a reducing agent will be explained.

Examples of the organic metal salt include silver salts of long chain aliphatic carboxylic acid such as silver laurate, silver myristate, silver palmitate, silver stearate, silver arachate and silver behenate; silver salts of an organic compound having an imino group such as benzotriazole silver salt, benzimidazole silver salt, carbazole silver salt and phthalazine silver salt; silver salts of a sulfur-containing compound such as s-alkylthioglycolate; silver salts of aromatic carboxylic acid such as silver benzoate and silver phthalate; silver salts of sulfonic acid such as silver ethanesulfonate; silver salts of sulfinic acid such as silver o-toluene sulfinate; silver salts of phosphoric acid such as silver phenylphosphate; silver barbiturate, silver saccharate, silver salt of salicylaldoxime and an arbitrary mixture of them.

Among them, long chain aliphatic carboxylic acid silver salt is preferable, and inter alia, behenic acid silver salt is more preferable. Alternatively, behenic acid may be used with a behenic acid silver salt.

The reducing agent can be appropriately used based on the description in JP-A No. 53-1020, page 227 left lower column line 14 to page 229 right upper column line 11. Inter alia, it is preferable to use mono, bis, tris or tetrakisphenols, mono or bisnaphthols, di or polyhydroxynaphthalenes, di or polyhydroxybenzenes, hydroxymonoethers, ascorbic acids, 3-pyrrazolidones, pyrazolines, reducing sugars, phenylenediamines, hydroxylamines, reductones, hydroxamic acids, hydrazides, amidoximes, and N-hydroxyureas.

Among the aforementioned reducing agents, aromatic organic reducing agents such as polyphenols, sulfonamidophenols and naphthol& are particularly preferable.

In order to assure sufficient transparency as a heat-sensitive recording material, it is preferable to use (a) a combination of an electron donating dye precursor and an electron accepting compound or (b) a combination of a photodegradable diazo compound and a coupler in the heat-sensitive recording layer. In the invention, it is preferable that any one of the color forming component A and the color forming component B is used by microcapsulation or conversion into composite fine particles, and it is more preferable that the electron donating dye precursor or the photodegradable diazo compound is used by microcapsulation or conversion into composite fine particles. A mode of microcapsulation of the electron donating dye precursor or the photodegradable diazo compound is most preferable from the viewpoint of image storability.

<Microcapsules>

For preparing microcapsules, there are an interfacial polymerization method, an internal polymerization method and external polymerization method, and any method can be adopted.

As described above, in the heat-sensitive recording material of the invention, it is preferable that an electron donating dye precursor or a photodegradable diazo compound is enclosed in microcapsules, and particularly, it is preferable to adopt an interfacial polymerization method of dissolving or dispersing, in a hydrophobic organic solvent, an electron donating dye precursor or a photodegradable diazo compound which is to be a core of a capsule to prepare an oil phase, placing the oil phase into an aqueous phase in which a water-soluble polymer has been dissolved, emulsifying and dispersing this by a stirring means such as a homogenizer, warming this to cause a polymer-forming reaction at the oil droplet interface, whereby a microcapsule wall comprising a polymer substance is formed.

A reactant for forming the polymer substance is added to the interior of an oil droplet and/or the outside of an oil droplet. Examples of the polymer substance include polyurethane, polyurea, polyamide, polyester, polycarbonate, urea-formaldehyde resin, melamine resin, polystyrene, styrene methacrylate copolymer and styrene-acrylate copolymer. Among them, polyurethane, polyurea, polyamide, polyester and polycarbonate are preferable, and particularly, polyurethane and polyurea are preferable.

For example, when polyurea is used as a capsule wall material, the microcapsule wall can be easily formed by reacting polyisocyanate such as diisocyanate, triisocyanate, tetraisocyanate and polyisocyanate prepolymers, and polyamine such as diamine, triamine and tetramine, a prepolymer having two or more amino groups, piperazine or a derivative thereof or polyol in the aqueous phase by an interfacial polymerization method.

In addition, for example, a composite wall comprising polyurea and polyamide or a composite wall comprising polyurethane and polyamide can be prepared by mixing polyisocyanate and a second substance (e.g. acid chloride or polyamine, polyol) which reacts therewith to form a capsule wall in a water-soluble polymer aqueous solution (aqueous phase) or an oil medium (oil phase) to be capsulated, emulsifying and dispersing them, and warming this. Details of a process for preparing this composite wall comprising polyurea and polyamide are described, for example, in JP-A No. 58-66948.

As the polyisocyanate compound, a compound having a tri- or more-functional isocyanate group is preferable, and a difunctional isocyanate compound may be used in combination. Specifically, examples thereof include, as well as a dimer or a trimer (biuret or isocyanurate) which is obtained from a main raw material of diisocyanate such as xylene diisocyanate or a water adduct thereof, hexamethylene diisocyanate, tolylene diisocyanate or a water adduct thereof and isophorone diisocyanate, a polyfunctionalized product such as an adduct of a polyol such as trimethylolpropane and a difinctional isocyanate such as xylilene diisocyanate or the like, a compound in which a high-molecular compound such as polyether having an active hydrogen such as polyethylene oxide is introduced into an adduct of a polyol such as trimethylol propane and a difunctional isocyanate such as xylilene diisocyanate, and a condensate of benzene isocyanate with formalin. Compounds described in JP-A No. 62-212190, JP-A No. 4-26189, JP-A No. 5-317694, and Japanese Patent Application No. 8-268721 are preferable.

It is preferable that the polyisocyanate is added so that an average particle diameter of microcapsules is 0.05 to 12 μm and a thickness of a capsule wall is 5 to 300 nm. A dispersed particle diameter is generally around 0.1 to 10 μm.

Examples of polyol or/and polyamine which reacts with polyisocyanate and is added to an aqueous phase and/or an oil phase as one of constitutional components of a microcapsule wall include propylene glycol, glycerin, trimethylolpropane, triethanolamine, DETA, sorbitol and hexamethylenediamine. When a polyol is added, a polyurethane wall is formed. It is preferable to maintain the reaction temperature high or add an appropriate polymerization catalyst in the aforementioned reaction because the reaction rate is enhanced. A polyisocyanate, a polyol, a reaction catalyst, or a polyamine for forming a part of a wall material are detailed, for example, in “Polyurethane Handbook” edited by Keiji Iwata (The Nikkan Kogyo Shimbun, Ltd., 1987).

If necessary, a metal-containing dye, a charge adjusting agent such as nigrosine, or other arbitrary additives may be added to the microcapsule wall. These additives can be contained in a capsule wall at formation of a wall or at an arbitrary time. Alternatively, if necessary, a monomer such as a vinyl monomer may be graft-polymerized in order to adjust electrification of a capsule wall surface.

Further, in order to allow a microcapsule wall to have wall quality excellent in substance permeability and rich in color formability even under lower temperature circumstances, it is preferable to use a plasticizer which is adapted to a polymer used as a wall material. The plasticizer has a melting point of preferably 50° C. or higher, more preferably 120° C. or lower. Among them, a plasticizer which is solid under ambient temperature can be used by appropriate selection. For example, when a wall material comprises polyurea or polyurethane, a hydroxyl compound, a carbamic acid ester compound, an aromatic alkoxy compound, an organic sulfoneamide compound, an aliphatic amide compound, and an arylamide compound are suitably used.

As an organic solvent used when an electron donating dye precursor is dissolved and a core of a microcapsule is formed at the time of the preparation of the oil phase, a low boiling point solvent having a boiling point of 50 to 150° C. which has high solubility and does not remain in a capsule after a capsulation reaction is preferable. Examples of such low boiling point solvent include ester organic solvents such as ethyl acetate, isopropyl acetate and butyl acetate, and methylene chloride, and ethyl acetate is most preferable.

When solubility of an electron donating dye precursor which is to be a solute is inferior, or when polarity of an electron donating dye precursor is high and it cannot be preferably separated from a microcapsule wall, a hydrophobic oil having a relatively high boiling point can be used together. Although the hydrophobic oil remains in a capsule also after a capsulation reaction, leading to a harmful influence such as deterioration in image storability in some cases, maleic acid ester such as tricresyl phosphate, and boric acid esters such as tributyl borate can be preferably used, and in particular, tricresyl phosphate is preferably used since emulsion stability and image storability are comparatively better.

In addition, as the hydrophobic organic solvent used when a photodegradable diazo compound is dissolved and a core of a microcapsule is formed at the time of the preparation of the oil phase, an organic solvent having a boiling point of 100 to 300° C. is preferable. Examples thereof include, in addition to esters, dimethylnaphthalene, diethylnaphthalene, diisopropylnaphthalene, dimethylbiphenyl, diisopropylbiphenyl, diisobutylbiphenyl, 1-methyl-1-dimethylphenyl-2-phenylmethane, 1-ethyl-1-dimethylphenyl-1-phenylmethane, 1-propyl-1-dimethylphenyl-1-phenylmethane, triallylmethane (e.g. tritoluylmethane, toluyldiphenylmethane), a terphenyl compound (e.g. terphenyl), an alkylated compound, alkylated diphenyl ether (e.g. propyl diphenyl ether), hydrogenated terphenyl (e.g. hexahydroterphenyl), and diphenyl ether. Among them, it is particularly preferable to use esters from the viewpoint of emulsion stability of an emulsified dispersion.

Examples of the esters include phosphate esters such as triphenyl phosphate, tricresyl phosphate, butyl phosphate, octyl phosphate and cresylphenyl phosphate; phthalate esters such as dibutyl phthalate, 2-ethylhexyl phthalate, ethyl phthalate, octyl phthalate and butylbenzyl phthalate; dioctyl tetrahydrophthalate; benzoate esters such as ethyl benzoate, propyl benzoate, butyl benzoate, isopentyl benzoate, and benzyl benzoate; abietate esters such as ethyl abietate, and benzyl abietate; dioctyl adipate; isodecyl succinate; dioctyl azelate; oxalate esters such as dibutyl oxalate, and dipentyl oxalate; diethyl malonate; maleate esters such as dimethyl maleate, diethyl maleate, dibutyl maleate; tributyl citrate; sorbate esters such as methyl sorbate, ethyl sorbate, and butyl sorbate; sebacate esters such as dibutyl sebacate, and dioctyl sebacate; monoesters and diesters of ethylene glycol and formic acid, butyric acid, lauric acid, palmitic acid, stearic acid or oleic acid; triacetin; diethyl carbonate; diphenyl carbonate; ethylene carbonate; propylene carbonate; borate esters such as tributyl borate, and tripentyl borate.

Among them, it is particularly preferable that tricresyl phosphate is used alone or by mixing since stability of an emulsion becomes best. It is also possible to use a plurality of the aforementioned oils or to use the oil with other oils.

When solubility of a photodegradable diazo compound to be capsulated in the hydrophilic organic solvent is inferior, it is also possible to use a low boiling point solvent having high solubility as an assistant. Preferable examples of such a low boiling point solvent include ethyl acetate, isopropyl acetate, butyl acetate, and methylene chloride.

On the other hand, in an aqueous phase to be used, as a protective colloid, an aqueous solution in which a water-soluble polymer is dissolved is used, the aforementioned oil phase is placed therein, and emulsification and dispersing are performed by a means such as a homogenizer. The water-soluble polymer makes dispersing uniform and easy, and serves as a dispersing medium for stabilizing an emulsification-dispersed aqueous solution. Herein, in order to perform emulsification and dispersing further umiformly and stabilize this, a surfactant may be added to at least one of an oil phase and an aqueous phase. As the surfactant, a well-known surfactant for emulsification can be used. The amount of the surfactant to be added is preferably 0.1 to 5%, more preferably 0.5 to 2% with respect to the mass of the oil phase.

As a surfactant to be contained in an aqueous phase, a surfactant which does not react with the protective colloid and thus does not cause precipitation or aggregation can be used by appropriately selecting from anionic or nonionic surfactants. Examples of a preferable surfactant include sodium alkylbenzenesulfonate, sodium alkylsulfate, a sodium, ammonium or triethanolamine salt of dioctyl sulfosuccinate, polyalkylene glycol (e.g. polyoxyethylene nonyl phenyl ether), and acetylene glycol.

An emulsification of an oil phase containing the aforementioned components and an aqueous phase containing a protective colloid and a surfactant can be easily performed using a stirring means which is used in conventional fine particle emulsification such as high speed stirring and ultrasound dispersing, for example, a known emulsifying apparatus such as a homogenizer, Manton Goolie, an ultrasound dispersing apparatus, a dissolver, and a Kedy mill. After emulsification, in order to promote a capsule wall-forming reaction, it is preferable to warm an emulsion to 30 to 70° C. In addition, in order to prevent aggregation between capsules during a reaction, it is preferable to add water to decrease a possibility of collision between capsules and perform sufficient stirring.

In addition, a dispersion for preventing aggregation may be further added during a reaction. With progression of a polymerization reaction, evolution of carbonic acid gas is observed, and cease of the evolution can be regarded as an approximate endpoint of a capsule wall-forming reaction. Usually, by a reaction for a few hours, an intended microcapsules can be obtained.

<Composite Fine Particles>

By using the same materials as those for preparing the microcapsules, composite fine particles used in the invention can be produced, for example, by heating, melting and mixing a dye precursor or a diazo compound, a polyvalent isocyanate compound, and if necessary, other components, then, emulsifying and dispersing this mixture in a water-dispersible medium in which a protective colloid substance has been dissolved, and if necessary, mixing a reactive substance such as polyamine, and warming this emulsified dispersion, to polymerize these polymer-forming materials, whereby a polymer is obtained.

Specifically, as one example, a dye precursor and a polyvalent isocyanate compound are heated and melted at between 30° C. and 100° C., and this is emulsification-dispersed using an emulsifying agent. The emulsification is performed at a rotation number of 10,000 for 10 minutes or less. As the emulsifying agent to be used, a known dispersing agent is used, and particularly, polyvinyl alcohol is preferable. Subsequently, by a reaction at 50° C. to 100° C. for 1 hour to 3 hours, the polyvalent isocyanate compound is polymerized. Thereafter, this is cooled to room temperature, whereby a dispersion of composite fine particles can be prepared.

In addition, there is also a method of using a polyvalent isocyanate compound as a solvent, dissolving a solute containing a dye precursor therein, and emulsification-dispersing the resulting solution in a hydrophilic colloid aqueous solution, thereby performing a reaction of polymerizing the polyvalent isocyanate compound. It is desirable that, as regards the size of the composite fine particle, the particle is made to be fine to some extent in order to obtain sufficient color forming sensitivity and color forming density. When the particle diameter of the composite fine particle is large, it is considered that heat is not transmitted to the central part of the composite fine particle and color forming becomes insufficient. In the invention, the particle diameter (average particle diameter) is preferably less than 1 μm, more preferably 0.8 μm or less, and further preferably 0.6 μm or less.

In the invention, the ratio of the dye precursor contained in the composite fine particles is preferably 40% by mass or more and more preferably 55% by mass or more, but preferably 80% by mass or less and more preferably 75% by mass or less of the total mass of the composite fine particles. And, it is considered that, by containing a dye precursor in a relatively large amount, a heat-sensitive recording body having a sufficient color forming ability is obtained, provided that a mode of microcapsules rather than composite fine particles is preferable from the viewpoint of image storability.

In the invention, when the electron donating dye precursor or the photodegradable diazo compound is used in a heat-sensitive recording layer of a heat-sensitive recording material, the content of the electron donating dye precursor is preferably 0.1 to 5.0 g/m², more preferably 1.0 to 4.0 g/m². And, the content of the photodegradable diazo compound is preferably 0.02 to 5.0 g/m², more preferably 0.10 to 4.0 g/m² from the viewpoint of color forming density. When the content of the electron donating dye precursor is in a range of 0.1 to 5.0 g/m², a sufficient color forming density is obtained, and when the contents of both are within 5.0 g/m², a sufficient color forming density is retained and transparency of the heat-sensitive recording layer can be retained.

<Emulsified Dispersion of Electron Accepting Compound or Coupler>

When capsulation is performed using an electron donating dye precursor or a photodegradable diazo compound as a core substance, or when composite fine particles are made, although an electron accepting compound or a coupler may be used, for example, by solid-dispersing it together with a water-soluble polymer, an organic base and other color forming aids by a means such as a sand mill, it is preferable that the electron accepting compound or the coupler is dissolved in a high boiling point organic solvent which is hardly soluble or insoluble in water in advance, mixed with a polymer aqueous solution (aqueous phase) containing a surfactant and/or a water-soluble polymer as a protective colloid, and emulsified by a homogenizer, and the resulting emulsified dispersion is used. In this case, if necessary, a low boiling point solvent may be used as a dissolution aid.

Further, a coupler and an organic base may be emulsification-dispersed separately, or they may be mixed, dissolved in a high boiling point organic solvent, and emulsification-dispersed. A preferable emulsification-dispersed particle diameter is 1 μm or less.

The high boiling point organic solvent used in this case can be appropriately selected from high boiling point oils described, for example, in JP-A No. 2-141279. Inter alia, it is preferable to use esters from the viewpoint of emulsification stability of the emulsified dispersion, and particularly, tricresyl phosphate is preferable. It is also possible to use a plurality of the oils in combination or to use the oil together with other oils.

The water-soluble polymer contained as a protective colloid can be appropriately selected from known anionic polymers, nonionic polymers and amphoteric polymers. A water-soluble polymer having a solubility of 5% or more in water at a temperature for emulsification is preferable, and examples thereof include polyvinyl alcohol or modified polyvinyl alcohol, polyacrylic acid amide or a derivative thereof, an ethylene-vinyl acetate copolymer, a styrene-maleic anhydride copolymer, an ethylene-maleic anhydride copolymer, an isobutylene-maleic anhydride copolymer, polyvinylpyrrolidone, ethylene-acrylic acid copolymer, a vinyl acetate-acrylic acid copolymer, cellulose derivatives such as carboxymethylcellulose and methylcellulose, casein, gelatin, a starch derivative, gum arabic, and sodium alginate. Among them, polyvinyl alcohol and modified polyvinyl alcohol, gelatin and modified gelatin and cellulose derivatives are particularly preferable.

In addition, the mixing ratio of an oil phase relative to an aqueous phase (oil phase mass/aqueous phase mass) is preferably 0.02 to 1.0, more preferably 0.1 to 0.6. When the mixing ratio is in a range of 0.02 to 1.0, an appropriate viscosity can be retained, preparation suitability is excellent, and coating solution stability is excellent.

When an electron accepting compound is used in the heat-sensitive recording material of the invention, the electron accepting compound is preferably 0.5 to 30 parts by mass, more preferably 1.0 to 10 parts by mass per 1 part by mass of the electron donating dye precursor.

In addition, when a coupler is used in the heat-sensitive recording material of the invention, the coupler is preferably 0.1 to 30 parts by mass, further preferably 1 to 10 parts by mass per 1 part by mass of the photodegradable diazo compound.

(Coating Solution for Heat-Sensitive Recording Layer)

A coating solution for a heat-sensitive recording layer can be prepared, for example, by mixing the microcapsule solution and the emulsified-dispersion prepared as described above. Herein, the water-soluble polymer used as a protective colloid at the time of the preparation of the microcapsule solution and the water-soluble polymer used as a protective colloid at the time of the preparation of the emulsified dispersion function as a binder in the heat-sensitive recording layer. Alternatively, aside from these protective colloids, a binder may be added and mixed to prepare a coating solution for a heat-sensitive recording layer.

The binder to be added is generally water-soluble, and examples thereof include polyvinyl alcohol or modified polyvinyl alcohol, hydroxyethylcellulose, hydroxypropylcellulose, epichlorohydrin-modified polyamide, an ethylene-maleic anhydride copolymer, a styrene-maleic anhydride copolymer, an isobutylene-maleic anhydride copolymer, polyacrylic acid, polyacrylic acid amide, methylol-modified polyacrylamide, a starch derivative, casein, gelatin and modified gelatin.

Alternatively, in order to impart water resistance to these binders, a water resistant agent may be added, or a hydrophobic polymer emulsion, specifically, a styrene-butadiene rubber latex or an acrylic resin emulsion may be added.

When the coating solution for a heat-sensitive recording layer is coated on a support, known coating means used for an aqueous or organic solvent system is used, and in this case, in order to coat a coating solution for a heat-sensitive recording layer stably and uniformly, and retain the strength of the coated film, in the heat-sensitive recording material of the invention, methylcellulose, carboxymethylcellulose, hydroxyethylcellulose, starches, gelatin and modified gelatin, polyvinyl alcohol and modified polyvinyl alcohol (e.g. carboxy-modified polyvinyl alcohol, acetoacetylated polyvinyl alcohol, terminally hydrophobicized modified polyvinyl alcohol), polyacrylamide, polystyrene or a copolymer thereof, polyester or a copolymer thereof, polyethylene or a copolymer thereof, an epoxy resin, an acrylate resin or a copolymer thereof, a methacrylate resin or a copolymer thereof, a polyurethane resin, a polyamide resin, and a polyvinyl butyral resin can be used.

(Other Components)

Other components which can be used in a heat-sensitive recording layer will be described below.

The other component is not particularly limited, and can be appropriately selected depending on necessity, and examples thereof include a known sensitizer, ultraviolet-ray absorbing agent, and an antioxidant.

The sensitizer may be contained in a heat-sensitive recording layer for the purpose of improving heat responsiveness.

Examples of the heat-meltable lubricant include aromatic ether, thioether, ester, aliphatic amide, and ureide.

These examples are described in JP-A No. 58-57989, JP-A No. 58-87094, JP-A No. 61-58789, JP-A No. 62-109681, JP-A No. 62-132674, JP-A No. 63-151478, JP-A No. 63-235961, JP-A No. 2-184489, and JP-A No. 2-215585.

Preferable examples of the ultraviolet absorbing agent include a benzophenone ultraviolet absorbing agent, a benzotriazole ultraviolet absorbing agent, a salicylic acid ultraviolet absorbing agent, a cyanoacrylate ultraviolet absorbing agent, and oxalic acid anilide ultraviolet absorbing agent. These examples are described in JP-A No. 47-10537, JP-A No. 58-111942, JP-A No. 58-212844, JP-A No. 59-19945, JP-A No. 59-46646, JP-A No. 59-109055, JP-A No. 63-53544, Japanese Patent Application Publication (JP-B) No. 36-10466, JP-B No. 42-26187, JP-B No. 48-30492, JP-B No. 48-31255, JP-B No. 48-41572, JP-B No. 48-54965, JP-B No. 50-10726, U.S. Pat. No. 2,719,086, U.S. Pat. No. 3,707,375, U.S. Pat. No. 3,754,919, and U.S. Pat. No. 4,220,711.

Preferable examples of the antioxidant include a hindered amine antioxidant, a hindered phenol antioxidant, an aniline antioxidant, and a quinoline antioxidant. These examples are described in JP-A No. 59-155090, JP-A No. 60-107383, JP-A No. 61-137770, JP-A No. 61-139481, and JP-A No. 61-160287.

The amount of the other components to be coated is preferably around 0.05 to 2.0 g/m², more preferably 0.1 to 1.0 g/m². Other components may be added to the interior of the microcapsule, or to the outside of the microcapsule.

The heat-sensitive recording layer is preferably a heat-sensitive recording layer having a wide energy amount width necessary for obtaining a saturated transmission density (D_{T-max}), that is, a wide dynamic range, in order to suppress a density unevenness caused by a slight difference in heat conductivity of a thermal head and obtain an image of high quality. It is preferable that the heat-sensitive recording material of the invention has the aforementioned heat-sensitive recording layer and has such a property that transmission density D_{T-max}=3.0 can be obtained at a thermal energy amount in a range of 70 to 130 mJ/mm².

It is preferable that the heat-sensitive recording layer is coated so that the dry coating amount after coating and drying is 1 to 25 g/m² and the thickness of the layer is 1 to 25 μm. It is also possible that the heat-sensitive recording layer may be used by laminating two or more layers. In this case, the dry coating amount of the entire heat-sensitive recording layer after coating and drying is preferably 1 to 25 g/m².

<Support>

When the heat-sensitive recording material of the invention is a transmission-type heat-sensitive recording material, it is preferable to. use a transparent support. As a transparent support, a transparent film is preferable, and examples thereof include synthetic polymer films such as polyester films such as polyethylene terephthalate (PET) and polybutylene terephthalate, cellulose triacetate film, and polyolefin films such as polypropylene and polyethylene. These may be used alone or by laminating them.

In medical use, a transparent support may be colored with a blue dye (e.g. dye-1 described in Examples of JP-A No. 8-240877), or may be colorless. It is preferable that a support is undercoated with gelatin or water-soluble polyester. Regarding an undercoating layer, those described, for example, in JP-A No. 51-11420, JP-A No. 51-123139, and JP-A No. 52-65422 can be utilized. The thickness of the support is preferably 25 to 250 μm, more preferably 50 to 210 μm.

In addition, the synthetic polymer film may be colored in an arbitrary hue. Examples of a method of coloring a polymer film include a method of kneading a resin with a dye before formation of a resin film and forming a film, and a method of preparing a coating solution in which a dye is dissolved in a suitable solvent and coating this on a colorless transparent resin film by a known coating method such as a gravure coating method, a roller coating method, and a wire coating method. Inter alia, a film obtained by forming a polyester resin such as polyethylene terephthalate and polyethylene naphthalate with a blue dye kneaded therein into a film and subjecting this to heat resistance treatment, stretching treatment or antistatic treatment is preferable.

Particularly, when the transparent heat-sensitive recording material of the invention is observed on a Schaukasten from a support side, illusion is caused by Schaukasten light transmitted through a transparent non-image part, and the image is difficult to see in some cases. In order to avoid this, it is particularly preferable to use, as a transparent support, a synthetic polymer film which is colored in blue within a region of a square formed by four points of A (x=0.2805, y=0.3005), B (x=0.2820, y=0.2970), C (x=0.2885, y=0.3015) and D (x=0.2870, y=0.3040) on a chromaticity coordinate defined by the method described in JIS-Z8701.

The invention is not limited to the aforementioned transmission-type heat-sensitive recording material, and as a support, known supports such as a paper, a paperboard, a pigment coated paper, a synthetic paper, a white polyester film, and a thermoplastic resin laminate paper (so-called resin coated paper) can be also used. In the case of a multicolor heat-sensitive recording material, from the viewpoint of glossiness, a resin coated paper, a synthetic paper, a white polyester film, or a support which is preferably used in a transmission-type heat-sensitive recording material is preferable.

<Other Layers>

In the heat-sensitive recording material of the invention, as other layers, an intermediate layer, an undercoating layer, a light shielding layer and a back layer can be provided on the support.

(Intermediate Layer)

The intermediate layer is preferably formed on the heat-sensitive recording layer.

The intermediate layer is provided for preventing mixing of layers or for shielding a gas (oxygen etc.) which is harmful to image storability. A binder to be used is not particularly limited, and polyvinyl alcohol, gelatin, polyvinylpyrrolidone and a cellulose derivative can be used depending on the system. Inter alia, gelatin is suitable for a recording material for medical diagnosis requiring formation of an image which is clear also in details, because since gelatin is such that an aqueous solution thereof has fluidity at high temperature and is excellent in a nature (setting property) of losing fluidity and gelating at low temperature (for example 35° C. or less), when coating solutions for forming a plurality of layers on a support are coated and dried to provide the layers, mutual mixing of adjacent two layers is effectively prevented in a method of successively coating and drying a plurality of layers and in a method of performing multilayer coating and drying at once by an exclusion dye method, the surface state of the resulting heat-sensitive recording material becomes better, and a heat-sensitive recording material which can form an image of high quality can be obtained. Since the surface state is not deteriorated even when dried at further higher wind velocity, the productivity is improved. As such a gelatin, any of unmodified (untreated) gelatin and modified (treated) gelatin is used without hindrance. Examples of the modified gelatin include lime-treated gelatin, acid-treated gelatin, and phthalation-treated gelatin. In addition, for imparting a coating property, various surfactants may be added.

(Undercoating Layer)

In the heat-sensitive recording material of the invention, for the purpose of preventing a heat-sensitive recording layer from peeling off from a support, an undercoating layer may be provided on a support before a heat-sensitive recording layer containing microcapsules or a light reflection preventing layer is coated.

As the undercoating layer, acrylic acid ester copolymer, polyvinylidene chloride, SBR and hydrophilic polyether can be used, and the thickness of the layer is preferably 0.05 to 0.5 μm.

Since when coating a heat-sensitive recording layer on an undercoating layer, the undercoating layer is swollen due to water contained in the coating solution for the heat-sensitive recording layer, whereby the image recorded on the heat-sensitive recoding layer is deteriorated in some cases, it is preferable that a hardener such as dialdehydes such as glutaraldehyde and 2,3-dihydroxy-1,4-dioxane and boric acid is used in the undercoating layer to harden it. The amount of these hardeners to be added depends on the weight of the materials for undercoating, and an appropriate addition amount can be selected in conformity with a desired hardening degree in a range of 0.2 to 3.0% by mass.

(Light Shielding Layer)

In the heat-sensitive recording material of the invention, a light shielding layer may be provided in order to prevent fading of an image due to light and background fogging. The light shielding layer is a layer wherein an ultraviolet absorbing agent is uniformly dispersed in a binder, and by effective absorption of ultraviolet light by this uniformly dispersed ultraviolet absorbing agent, discoloration of the background due to ultraviolet light and discoloration or fading of the image part are prevented. Regarding a method of making a light shielding layer and compounds to be used, in addition to benzotriazole, benzophenone and hindered amine ultraviolet absorbing agents, those described in JP-A No. 4-197778 can be utilized.

(Back Layer)

It is preferable that the heat-sensitive recording material of the invention has a heat-sensitive recording layer containing microcapsules on one side of the support, and has a back layer on the other side of the support. For the purpose of imparting transportability and preventing light reflection, a matting agent is preferably added to a back layer. By addition of a matting agent, the glossiness measured at an incident light angle of 20° is preferably 50% or lower, more preferably 30% or lower. Examples of the matting agent include, in addition to fine particles of starch obtained from barley, wheat, corn, rice or beans, fine particles of a synthetic polymer such as a cellulose fiber, a polystyrene resin, an epoxy resin, a polyurethane resin, a urea formalin resin, a poly(meth)acrylate resin, a polymethyl (meth)acrylate resin, a copolymer resin of vinyl chloride or vinyl acetate, and polyolefin, and fine particles of inorganic substances such as calcium carbonate, titanium oxide, kaolin, smectite clay, aluminum hydroxide, silica, and zinc oxide.

It is preferable that the average particle diameter of the matting agent is in a range of 0.5 to 20 μm, preferably in a range of 0.5 to 10 μm. The matting agents may be used alone, or two or more kinds thereof may be used together. In addition, from the viewpoint of better transparency of a heat-sensitive recording material, the refractive index is preferably in a range of 1.4 to 1.8. From the viewpoint of improvement in the hue, the back layer may contain various dyes (e.g. C.I.Pigment Blue 60, C.I.Pigment Blue 64, described in THE THEORY OF THE PHOTOGRAPHIC PROCESS 4th EDITION, page 77 to page 87), and a vinylsulfone compound is preferable.

<<Process for Manufacturing Heat-Sensitive Recording material>>

A process for manufacturing the heat-sensitive recording material of the invention will be explained below. The manufacturing process of the invention comprises coating a coating solution for a heat-sensitive recording layer on a support to form a heat-sensitive recording layer, coating a coating solution for forming a protective layer on the heat-sensitive recording layer to form a protective layer, and if necessary, forming other layers.

Herein, the heat-sensitive recording layer and the protective layer may be formed at the same time, and in that case, by multilayer coating the coating solution for forming a heat-sensitive recording layer and the coating solution for forming a protective layer on the support at the same time, the heat-sensitive recording layer and the protective layer thereon can be formed at the same time.

As a support used herein, the already explained support which is used in the heat-sensitive recording material of the invention can be used. In addition, as the coating solution for forming a heat-sensitive recording layer, the aforementioned coating solution for forming a heat-sensitive recording layer can be used, and as the coating solution for forming a protective layer, the aforementioned coating solution for a protective layer containing a pigment and a binder can be used. And, examples of the other layers include the aforementioned undercoating layer, intermediate layer, light shielding layer, back layer and other layers. The heat-sensitive recording material of the invention may be coated by any method. Specifically, various coating procedures including extrusion coating, slide coating, curtain coating, knife coating, immersion coating, flow coating, and extrusion coating using a kind of hopper described in U.S. Pat. No. 2,681,294 are used, extrusion coating or slide coating described in Stephen F. Kistler, Petert M. Schwaizer, REQUITED FILM COATING (published by CHAPMAN&HALL, 1997) page 399 to page 536 are preferably used, and particularly preferably, the slide coating is used.

An example of a shape of a slide coater used in the slide coating is in FIG. 11b.1 on page 427 of the same document. If desired, two layers or more layers can be coated at the same time by the method described in the same document, page 399 to page 536, or the method described in U.S. Pat. No. 2,761,791 and British Patent No. 837095. For drying, the material is dried at a dry-bulb temperature of 20 to 65° C. preferably 25 to 50° C., at a wet-bulb temperature of 10 to 30° C., preferably with a drying wind at 15 to 25° C.

In the recording method of the invention, thermal energy is applied to the already described heat-sensitive recording material of the invention by using a thermal head which includes a layer having a carbon ratio of 90% by mass or more as an uppermost layer.

Since the heat-sensitive recording material of the invention contains a particular lubricant, a sufficient head matching property can be obtained even when using a thermal head which includes an uppermost layer having a carbon ratio of 70% or more, further 75% or more, particularly 90% or more, which is excellent in abrasion resistance but is low in surface energy and has a defect that a lubricant contained in a heat-sensitive recording layer or a protective layer is difficult to wet when recording. For this reason, the heat-sensitive recording material of the invention can be suitably used particularly in the field requiring high-image quality such as a medical recording medium.

Since the heat-sensitive recording material of the invention contains a particular lubricant (betaine compound represented by the formula (1)), when recorded by a thermal head including an uppermost layer having a carbon ratio of 90% or more, which is excellent in abrasion resistance, the surface roughening and sticking are better and the head matching property is excellent over a wide recording energy region, particularly in a high recording energy region, and the material is preferable as a medical recording material requiring a wide dynamic range.

### EXAMPLES

The present invention will be specifically explained below by way of Examples, but the invention is not limited by them at all. Unless otherwise indicated, “%” represents “% by mass”.

### Example 1

<Preparation of Coating Solution for Protective Layer>

(Preparation of Pigment Dispersion for Protective Layer)

Thirty gram of stearic acid-treated aluminum hydroxide (tread name: Hijilite H42S manufactured by SHOWA DENKO K.K.) as a pigment was added to 110 g of water, this was stirred for 3 hours, and 0.8 g of a dispersing aid (tread name: Poise 532A manufactured by Kao Corporation), 30 g of a 9.4% aqueous polyvinyl alcohol solution (tread name: PVA105, manufactured by Kuraray Co., Ltd.) and 10 g of an aqueous solution of a compound represented by the following structural formula [100] which had been adjusted to 2% were added thereto, and dispersed by a sand mill to obtain a pigment dispersion for a protective layer of an average particle diameter of 0.30 μm.

As the “average particle diameter”, an average particle diameter of pigment particles corresponding to a 50% volume of all the pigment which is obtained by dispersing a pigment to be used in the presence of a dispersing agent, adding water to the pigment dispersion immediately after the dispersing to dilute to 0.5% to obtain a test solution, placing the test solution in warm water at 40° C., adjusting the light transmittance to 75±1%, treating this with ultrasonic wave for 30 seconds, and measuring the diameter by a laser diffraction particle size distribution measuring apparatus (tread name: LA700, manufactured by Horiba, Ltd.) is used. 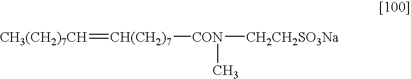
(Preparation of Coating Solution for Protective Layer)

Ninety point zero gram of a 8.0% aqueous polyvinyl alcohol solution (trade name: PVA124C manufactured by Kuraray Co., Ltd.), 61.6 g of the aforementioned pigment dispersion for a protective layer, 5.6 g of a 20.5% zinc stearate dispersion (tread name: F115, manufactured by Chukyo Yushi Co., Ltd.; melting point 125° C.), 3.2 g of a 18.0% stearic acid dispersion (trade name; Cellosol 920, manufactured by Chukyo Yushi Co., Ltd.; melting point 60° C.), 5.0 g of a 35% silicone oil dispersion in water (tread name; BY22-840, manufactured by Dow Corning Toray Co., Ltd. liquid at ambient temperature), 4.0 g of “a dispersion obtained by mixing 20 g of glycerin tri-12-hydroxystearate having a melting point of 80° C. into 20.0 g of a 10.0% aqueous polyvinyl alcohol solution (trade name: MP103, manufactured by Kuraray Co., Ltd.), 10 g of a 2% aqueous sodium dioctylsulfosuccinate solution and 61 g of water, and dispersing this by a sand mill to an average particle diameter of 0.3 μm”, 10.0 g of a 4.0% aqueous boric acid solution, 8.0 g of 2% acetic acid, 1.5 g of a 75% solution of an acetylene glycol surfactant (trade name; Surfinol 104, manufactured by Nisshin Chemicals Co., Ltd.), 17.5 g of a 6.0% aqueous styrepe maleic acid copolymer ammonium salt solution (trade name; Polymalon 385, manufactured by Arakawa Chemical Industries, Ltd.), 14.0 g of 20% colloidal silica (trade name; Snowtex O, manufactured by Nissan Chemical Industries, Ltd.) and 34.0 g of “a solution obtained by adding the aforementioned exemplified compound (B-1) which is a betaine compound represented by the formula (1) to a water/ethanol mixed solution to a content of 5%” were mixed in 31.0 g of water, to obtain a coating solution for a protective layer.

(Preparation of Coating Solution for Heat-Sensitive Recording Layer)

A microcapsule solution containing an electron donating dye precursor as a core substance, and an electron accepting compound emulsified dispersion were prepared as follows.

(Preparation of Microcapsule A Solution)

As an electron donating dye precursor, 11.7 g of a compound represented by the following structural formula [201], 1.5 g of a compound represented by the following structural formula [202], 2.2 g of a compound represented by the following structural formula [203], 5.65 g of a compound represented by the following structural formula [204], 1.2 g of a compound represented by the following structural formula [205], 1.1 g of a compound represented by the following structural formula [206], and 0.57 g of a compound represented by the following structural formula [207] were added to 24.3 g of ethyl acetate, and the mixture was heated to 70° C. to dissolve the materials, and this was cooled to 45° C. Then, 15.4 g of a capsule wall material (trade name: Takenate D140N, manufactured by Takeda Chemical Industries, Ltd.) was added thereto, and this was mixed.

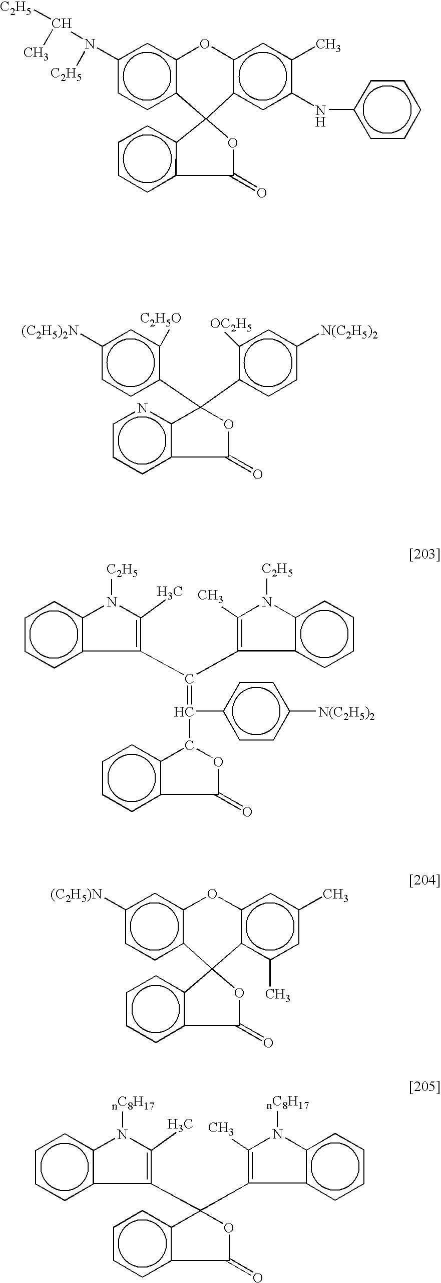

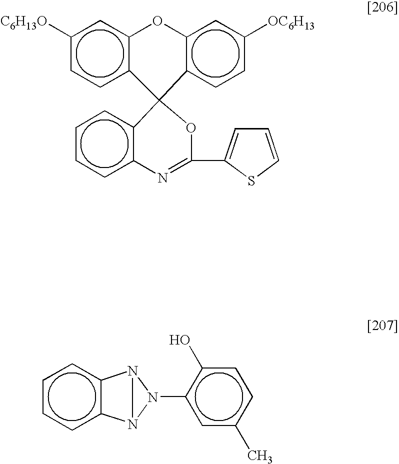

This solution was added to an aqueous phase obtained by mixing 48 g of a 8% aqueous polyvinyl alcohol solution (trade name: MP-103, manufactured by Kuraray Co., Ltd.) into 16 g of water, and emulsification was performed at a rotation number of 15000 rpm using an Ace homogenizer (manufactured by Nippon Seiki Co., Ltd.). After 110 g of water and 1.0 g of tetraethylenepentamine were added to the resulting emulsion, a capsulation reaction was performed at 60° C. for 4 hours to obtain a microcapsule solution A having an average particle diameter of 0.8 μm.

(Preparation of Microcapsule Solution B)

As an electron donating dye precursor, 12.2 g of a compound represented by the structural formula [201], 1.6 g of a compound represented by the structural formula [202], 2.4 g of a compound represented by the structural formula [203], 3.3 g of a compound represented by the structural formula [204], 1.5 g of a compound represented by the structural formula [205], 0.2 g of a compound represented by the structural formula [206], and 0.5 g of a compound represented by the structural formula [207] were added to 21 g of ethyl acetate, the mixture was heated to 70° C. to dissolve, and this was cooled to 45° C. 16.6 g of a capsule wall material (trade name; Takenate D127 N, manufactured by Takeda Chemical Industries, Ltd.) was added thereto, and this was mixed.

This solution was added to an aqueous phase obtained by mixing 48 g of a 8% aqueous polyvinyl alcohol solution (trade name: MP-103, manufactured by Kuraray Co., Ltd) into 16 g of water, and emulsification was performed at a rotation number of 15000 rpm using an Ace homogenizer (manufactured by Nippon Seiki Co., Ltd.). After 110 g of water and 1.0 g of tetraethylenepentamine were added to the resulting emulsion, a capsulation reaction was performed at 60° C. for 4 hours to obtain a microcapsule solution B having an average particle diameter of 0.3 μm.

(Preparation of Electron Accepting Compound Emulsified Dispersion)

Twenty two gram of a compound represented by the following structural formula [301], 8 g of a compound represented by the following structural formula [302], 2.6 g of a compound represented by the following structural formula [303], 2.6 g of a compound represented by the following structural formula [304], and 0.5 g of a compound represented by the following structural formula [306] as an electron accepting compound, and 4 g of a compound represented by the following structural formula [307] as an ultraviolet absorbing agent, together with 1.0 g of tricresyl phosphate and 0.5 g of diethyl maleate, were added to 16.5 g of ethyl acetate, and the mixture was heated to 70° C. to dissolve. This solution was added to an aqueous phase obtained by mixing 67 g of water, 55 g of a 8% aqueous polyvinyl alcohol solution (trade name; PVA217C, manufactured by Kuraray Co., Ltd), 19.5 g of a 15% aqueous polyvinyl alcohol solution (trade name: PVA205C, manufactured by Kuraray Co., Ltd), 11 g of a 2 weight % aqueous solution of a compound represented by the following structural formula [401] and 11 g of a 2% aqueous solution of a compound represented by the following structural formula [402], and this was emulsified to an average particle diameter of 0.7 μm at a rotation number of 10000 rpm using an Ace homogenizer (manufactured by Nippon Seiki Co., Ltd.), to obtain an electron accepting compound emulsified dispersion. 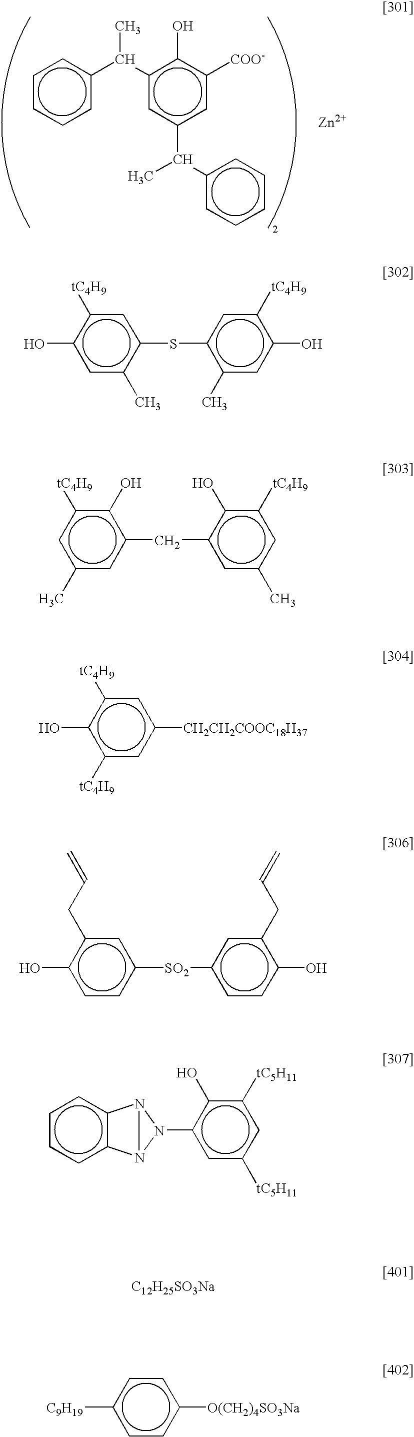
(Preparation of Coating Solution A for Heat-Sensitive Recording Layer)

Twenty four gram of the microcapsule solution A (solid matter concentration 23%), 55 g of the microcapsule solution B (solid matter concentration 24%), 100 g of the electron accepting compound emulsified dispersion (solid matter concentration 22%), 1.3 g of a 50% aqueous solution of a compound represented by the following structural formula [403], 3.6 g of colloidal silica (trade name: Snowtex O, manufactured by Nissan Chemical Industries, Ltd.) and 6.7 g of water were mixed to prepare a coating solution A for a heat-sensitive recording layer. 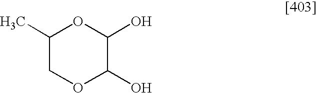
(Preparation of Coating Solution B for Heat-Sensitive Recording Layer)

Twelve point five gram of the microcapsule A solution (solid matter concentration 23%), 14.5 g of the microcapsule B solution (solid matter concentration 24%), 100 g of the electron accepting compound emulsified dispersion (solid matter concentration 22%), 1.2 g of a 50% aqueous solution of a compound represented by the structural formula [403], 4.5 g of colloidal silica (trade name: Snowtex, manufactured by Nissan Chemical Industries, Ltd.) and 14.5 g of water were mixed to prepare a coating solution B for a heat-sensitive recording layer.

(Preparation of Intermediate Layer Coating Solution)

After 7848 g of water was added to 1 kg of lime-treated gelatin to dissolve it, 137 g of a 5% solution (water/methanol=1/1 volumetric mixing solvent) in which di-2-ethylhexylsulfosuccinic acid sodium salt (Nissan Lapizole B90, manufactured by Nippon Oil & Fats Co., Ltd.) had been dissolved was added to prepare a coating solution for an intermediate layer.

(Preparation of Coating Solution A for Back Layer)

Water was added to 1 kg of lime-treated gelatin, 757 g of a dispersion containing 12% of spherical PMMA particles having an average particle diameter of 5.7 μm and 4.5% of gelatin, 3761 g of an emulsion of an ultraviolet absorbing agent containing compounds represented by following structural formulas [501] to [505] at following contents (the content of the ultraviolet absorbing agent per 1 kg of the emulsion is 9.8 g of a compound represented by the structural formula [501], 8.4 g of a compound represented by the structural formula [502], 9.8 g of a compound represented by the following structural formula [503], 13.98 g of a compound represented by the structural formula [504] and 29.3 g of a compound represented by the structural formula [505]), 1.75 g of 1,2-benzisothiazoline-3-one, 64.2 g of poly(sodium p-vinylbenzenesulfonate) (molecular weight: about 400 thousand), 15.0 g of a compound represented by the structural formula [506], 3180 mL of a 20% latex solution of polyethyl acrylate, 75.0 g of N,N-ethylene-bis (vinylsulfonylacetamide), and 25 g of 1,3-bis(bissulfonylacetamido)propane, to a total amount of 57.1 liter. 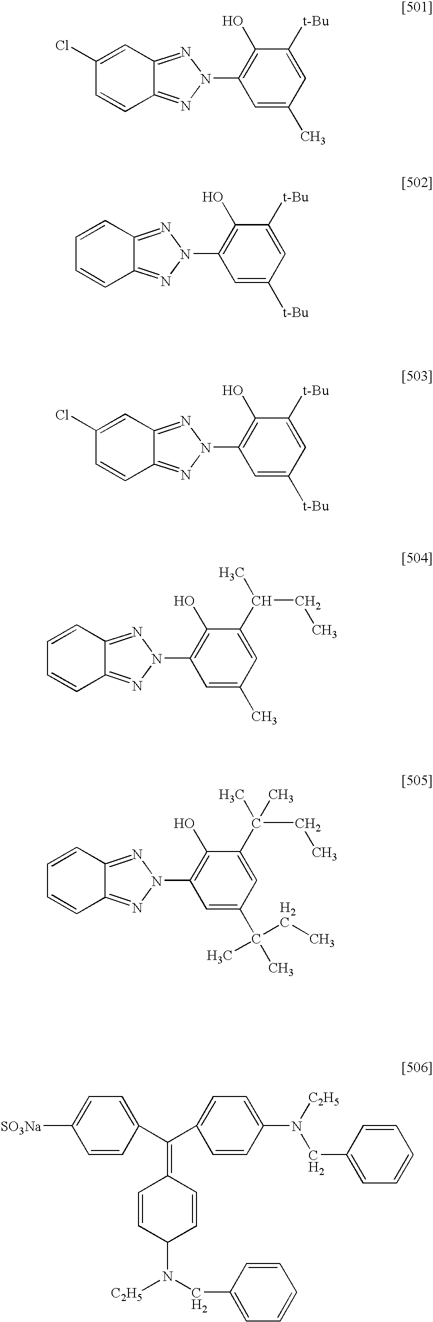
(Preparation of Coating Solution B for Back Layer)

One kilogram of lime-treated gelatin, 2000 g of a dispersion containing 15% of spherical PMMA particles having an average particle diameter of 0.71 μm and 7.0% of gelatin, 1268 ml of methanol, 1.75 g of 1,2-benzisothiazoline-3-one, 64.4 g of polysodium acrylate (molecular weight: about 100 thousand), 54 g of poly(sodium p-vinylbenzenesulfonate) (molecular weight: about 400 thousand), 25.2 g of sodium p-tert-octylphenoxypolyoxyethylene-ethylenesulfonate, 5.3 g of sodium N-propyl-N-polyoxyethylene-perfluorooctanesulfonic acid amide butylsulfonate, and 7.1 g of potassium perfluorooctane sulfonate were used, the pH was adjusted to 7.0 with sodium hydroxide, and water was added to a total amount of 66.79 liter.

[Preparation of Heat-Sensitive Recording Material]

(Preparation of Back Layer)

A coating solution A for a back layer and a coating solution B for a back layer were simultaneously multilayer-coated in this order at a coating amount of 40 mL/m² and 18.5 mL/m², respectively, on one side of a biaxially stretched polyethylene terephthalate support of a thickness of 180 μm which had been blue-colored at X=0.2850 and Y=0.2995 on a chromaticity coordinate defined by the method described in JIS-Z8701, by a slide bead method, followed by drying. The coating and drying condition is as follows. The coating speed was 160 m/min, the distance between the edge of the coating die and the support was 0.10 to 0.30 mm, and the pressure in the reduced pressure chamber was set lower than atmospheric pressure by 200 to 1000 Pa. The support was subjected to electricity removal with an ion wind before coating. In a subsequent chilling zone, the coating solution was cooled with a wind at a dry-bulb temperature of 0 to 20° C., this was transported contactlessly, and dried with a drying wind at a dry-bulb temperature of 23 to 45° C. and a wet-bulb temperature of 15 to 21° C. by a helical contactless-type drying apparatus.

(Preparation of Heat-Sensitive Recording Material)

On a side of the support opposite to the side on which the back layer had been coated, a coating solution A for a heat-sensitive recording layer, a coating solution B for a heat-sensitive recording layer, a coating solution for an intermediate layer, and a coating solution for a protective layer were simultaneously multilayer-coated in this order from a side near the support at coating amounts of 50 mL/m², 20 mL/m², 18.2 mL/m² and 24.3 mL/m², respectively, by a slide bead method, and this was dried to obtain a transparent heat-sensitive recording material of the invention having a heat-sensitive recording layer A, a heat-sensitive recording layer B, an intermediate layer and a protective layer on the support. The temperature of the coating solution for each layer was adjusted in a range of 33° C. to 37° C. The drying condition is as follows. The coating speed was 160 m/min, the distance between the coating die edge and the support was 0.10 to 0.30 mm, and the pressure in the reduced pressure chamber was set lower than atmospheric pressure by 200 to 1000 Pa. The support was subjected to electricity removal with an ion wind before coating. In a subsequent initial drying zone, the material was dried with a wind at 45° C. to 55° C. and a dew point of 0 to 5° C., transported contactlessly, and dried with a drying wind at a dry-bulb temperature of 30 to 45° C. and a wet-bulb temperature of 17 to 23° C. by a helical contactless-type drying apparatus, and after drying, the humidity was adjusted at a humidity of 40 to 60% at 25° C.

<Evaluations>

(Surface Roughening)

Recording was performed on the resulting heat-sensitive recording material by a thermal head (trade name: KGT, 260-12MPH8, manufactured by Kyocera Corporation) having a width of 37 cm in which a carbon layer having a thickness of 2 μm and a carbon ratio of 98% had been provided as an uppermost layer by a physical deposition method, at a head pressure of 10 Kg, while the transmission density of the image part of the heat-sensitive recording material was adjusted to be “3.5”, and whether surface roughening is caused or not at the time of image printing was evaluated visually according to the following criteria. Results are shown in Table 1. Surface roughening refers to the state where the surface glossiness is reduced and smoothness is deteriorated on an image printing surface, before the state of sticking.

[Criteria]

A: Surface roughening is not generated, and a high glossiness feeling is obtained.

B: Surface roughening is not generated.

C: Generation of surface roughening is recognized by a magnifying glass (low glossiness feeling).

D: Surface roughening is clearly recognized visually.

(Sticking)

In addition, in the aforementioned recording, whether sticking is caused or not at the time of image printing was evaluated visually in the aforementioned sample, according to the following criteria. Results are shown in Table 1.

[Criteria]

A: Sticking is not generated.

B: Generation of sticking is recognized by a magnifying glass, and this may be a problem.

C: Sticking is clearly recognized visually.

(Whitening)

Further, a heat-sensitive recording material one hour after recording was rubbed with a finger, and a whitening degree with time was evaluated visually according to the following criteria. Results are shown in Table 1.

A: A trace of rubbing is not observed.

B: A trace of rubbing is slightly observed, but is an acceptable level.

C: A trace of rubbing is observed, and this is outside an acceptable level.

D: A trace of rubbing is clearly observed, and quality is deteriorated.

(Conveying Torque)

For the prepared samples, an image of 5 cm was printed on each sample having a width of 37 cm by the aforementioned thermal head at three kinds of energies (35 mJ/mm², 60 mJ/mm², 90 mJ/mm²) under the condition of a head pressure of 10 kg and a conveying rate of 7 mm/s. As a measuring apparatus and method, a torsion bar is connected between a platen roll and a conveying motor, and a torque at the time of image printing with three kinds of energies was measured and evaluated by a torque meter (AMHERST, NH. USAVibrac loading torque measuring apparatus II) via the bar. Results are shown in Table 1.

### Example 2

According to the same manner as that of Example 1 except that, in “Preparation of coating solution for protective layer” in Example 1, 34.0 g of the “solution obtained by adding the aforementioned exemplified compound (B-1) to a water-methanol mixed solution to a content of 5%” was changed to 34.0 g of “a solution obtained by adding the aforementioned exemplified compound (B-4) which is a betaine compound represented by the formula (1) to a water-methanol mixed solution to a content of 5%”, a heat-sensitive recording material was manufactured, and evaluation was performed as in Example 1. Results are shown in Table 1.

### Example 3

According to the same manner as that of Example 1 except that, in “Preparation of coating solution for protective layer” in Example 1, 34.0 g of the “solution obtained by adding the aforementioned exemplified compound (B-1) to a water-methanol mixed solution to a content of 5%” was changed to 34.0 g of “a solution obtained by adding the aforementioned exemplified compound (B-S) which is a betaine compound represented by the formula (1) to a water/methanol mixed solution to a content of 5%”, a heat-sensitive recording material was manufactured, and evaluation was performed as in Example 1. Results are shown in Table 1.

### Example 4

According to the same manner as that of Example 1 except that, in “Preparation of coating solution for protective layer” in Example 1, 34.0 g of the “solution obtained by adding the aforementioned exemplified compound (B-1) to a water-methanol mixed solution to a content of 5%” was changed to 34.0 g of “a solution obtained by adding the aforementioned exemplified compound (B-2) which is a betaine compound represented by the formula (1) to a water/methanol mixed solution to a content of 5%”, a heat-sensitive recording material was manufactured, and evaluation was performed as in Example 1. Results are shown in Table 1.

### Example 5

According to the same manner as that of Example 1 except that, in “Preparation of coating solution for protective layer” in Example 1, 34.0 g of the “solution obtained by adding the aforementioned exemplified compound (B-1) to a water/methanol mixed solution to a content of 5%” was changed to 34.0 g of “a solution obtained by adding the exemplified compound (B-6) which is a betaine compound represented by the formula (1) to a water/methanol mixed solution to a content of 5%”, a heat-sensitive recording material was manufactured, and evaluation was performed as in Example 1. Results are shown in Table 1.

### Example 6

According to the same manner as that of Example 1 except that, in “Preparation of coating solution for protective layer” in Example 1, 34.0 g of the “solution obtained by adding the aforementioned exemplified compound (B-1) to a water/methanol mixed solution to a content of 5%” was changed to 34.0 g of “a solution obtained by adding the aforementioned exemplified compound (B-7) which is a betaine compound represented by the formula (1) to a water/methanol mixed solution to a content of 5%”, a heat-sensitive recording material was prepared, and evaluation was performed as in Example 1. Results are shown in Table 1.

### Example 7

According to the same manner as that of Example 2 except that, in “Preparation of coating solution for protective layer” in Example 2, the amount of water to be used was changed to 29.9 g, and 1.1 g of polyoxyethylene alkyl phosphoric acid ester (trade name: PrisurfA217E, manufactured by Dai-ichi Kogyo Seiyaku Co., Ltd.; melting point 38° C.) was further added, a heat-sensitive recording material was manufactured, and evaluation was performed as in Example 2. Results are shown in Table 1.

### Comparative Example 1

According to the same manner as that of Example 1 except that, in “Preparation of coating solution for protective layer” in Example 1, the amount of water to be added was changed to 65.0 g, and the “solution obtained by adding the aforementioned exemplified compound (B-1) to a water/methanol mixed solution to a content of 5%” was not added, a heat-sensitive recording material was manufactured, and evaluation was performed as in Example 1. Results are shown in Table 1.

### Comparative Example 2

According to the same manner as that of Example 1 except that, in “Preparation of coating solution for protective layer” in Example 1, the “solution obtained by adding the aforementioned exemplified compound (B-1) to a water/methanol mixed solution to a content of 5%” was not added, and addition amounts of the 20.5% zinc stearate dispersion (trade name; F115), the “dispersion obtained by mixing 20 g of glycerin tri-12-hydroxystearate having a melting point of 80° C. into 61 g of water and dispersing this to an average particle diameter of 0.3 μm by a sand mill”, the 18.0% stearic acid dispersion (trade name; Cellozole 920), and the 35% silicone oil water dispersion (trade name; BY22-840) were increased to 1.5-fold, respectively, a heat-sensitive recording material was manufactured, and evaluation was performed as in Example 1. Results are shown in Table 1.

### Comparative Example 3

According to the same manner as that of Example 1 except that, in “Preparation of coating solution for protective layer” in Example 1, the amount of water to be used was changed to 63.9 g, the “solution obtained by adding the aforementioned exemplified compound (B-1) to a water/methanol mixed solution to a content of 5%” was not added, and 1.1 g of polyoxyethylene alkyl phosphoric acid ester (trade name; PrisurfA217E, manufactured by Dai-ichi Kogyo Seiyaku Co., Ltd.; melting point 38° C.) was further added, a heat-sensitive recording material was manufactured, and evaluation was performed as in Example 1. Results are shown in Table 1.

### Comparative Example 4

According to the same manner as that of Example 1 except that, in “Preparation of coating solution for protective layer” in Example 1, the amount of water to be used was changed to 63.9 g, the “solution obtained by adding the aforementioned exemplified compound (B-1) to a water/methanol mixed solution to a content of 5%” and the “dispersion obtained by mixing 20 g of glycerin tri-12-hydroxystearate having a melting point of 80° C. into 61 g of water and dispersing this to an average particle diameter of 0.3 μm by a sand mill” were not added, and 4.0 g of a 21.5% stearic acid amide compound dispersion (trade name; G-270, manufactured by Chukyo Yushi Co., Ltd.; melting point 100° C.) and 1.1 g of polyoxyethylene alkyl phosphoric acid ester (trade name; PrisurfA217E, manufactured by Dai-ichi Kogyo Seiyaku Co., Ltd.; melting point 38° C.) were further added, a heat-sensitive recording material was manufactured, and evaluation was-performed as in Example 1. Results are shown in Table 1.

### Comparative Example 5

According to the same manner as that of Example 1 except that, in “Preparation of coating solution for protective layer” in Example 1, the amount of water to be used was changed to 62.1 g, the “solution obtained by adding the aforementioned exemplified compound (B-1) to a water/methanol mixed solution to a content of 5%”, the “dispersion obtained by mixing 20 g of glycerin tri-12-hydroxystearate having a melting point of 80° C. into 61 g of water and dispersing this to an average particle diameter of 0.3 pm by a sand mill”, the 20.5% zinc stearate dispersion (trade name; F115) and the 18.0% stearic acid dispersion (trade name; Cellosol 920, manufactured by Chukyo Yushi Co., Ltd.) were not added, and 4.1 g of a 28% ethylene bisstearoamide dispersion (trade name; Hidrin B961, manufactured by Chukyo Yushi Co., Ltd.; melting point 140° C.), 4.0 g of a 22% methylolstearic acid amide dispersion (trade name: Hidrin D130, manufactured by Chukyo Yushi Co., Ltd.; melting point 101° C.) and 2.0 g of a 30% paraffin wax dispersion (trade name: Hidrin D-337, manufactured by Chukyo Yushi Co., Ltd.; melting point 68° C.) were further added, a heat-sensitive recording material was manufactured, and evaluation was performed as in Example 1. Results are shown in Table 1.

### Example 8

(Preparation of Pigment Coating Solution for Protective Layer)

(1) After 280 g of aluminum hydroxide surface treated with stearic acid (trade name; Hijilite H42S, manufactured by SHOWA DENKO K.K.) as a pigment was added to 900 g of water and this was stirred for 3 hours, 8.5 g of a dispersing aid (trade name; Poise 532A, Kao Corporation), 300 g of a 10% aqueous polyvinyl alcohol solution (trade name; PVA105, manufactured by Kuraray Co., Ltd.), and 75 g of an aqueous solution of a compound represented by the structural formula [100] which had been adjusted to 2% were added thereto, the mixture was dispersed to an average particle diameter of 0.33 μm by a sand mill, and water was added thereto to adjust the concentration to 18%, to obtain a pigment dispersion for a protective layer. The “average particle diameter” was measured in the same manner as in the pigment of Example 1.

(2) Preparation of Lubricant Dispersion for Protective Layer-1

After 110 g of glycerin tri-12-hydroxystearate (trade name; K3 Wax 500, manufactured by Kawaken Fine Chemicals Co., Ltd.) as a lubricant was added to 280 g of water and the mixture was stirred for 3 hours, 3 g of a dispersing aid (trade name; Poise 532A, manufactured by Kao Corporation), 340 g of a 10% aqueous polyvinyl alcohol solution (trade name; MP103, manufactured by Kuraray Co., Ltd.), and 34 g of an aqueous solution of a compound represented by the structural formula [100] which had been adjusted to 2% were added thereto, this was dispersed to an average particle diameter of 0.26 μm by a sand mill, and water was added to adjust to a solid matter concentration of 18%, to obtain a lubricant dispersion for a protective layer-1. Herein, the concentration of glycerin tri-12-hydroxystearate which is a lubricant is 13.6%. The “average particle diameter” was measured as in the pigment of Example 1.

(3) Preparation of Lubricant Dispersion for Protective Layer-2

After 0.44 g of a dispersing aid (trade name; Poise 532A, manufactured by Kao Corporation), 83 g of a 5.8% aqueous polyvinyl alcohol solution (trade name; MP103, manufactured by Kuraray, Co., Ltd.) and 5.3 g of an aqueous solution of a compound represented by the structural formula [100] which had been adjusted to 2% were added to 6.4 g of water, 15.3 g of the aforementioned exemplified compound (A-08) as a lubricant was added, and this was stirred, this was dispersed to an average particle diameter of 0.45 μm by a sand mill, to obtain a lubricant dispersion for a protective layer-2 having a solid matter concentration of 18.6%. Herein, the concentration of A-08 which is a lubricant is 13.9%. As the “average particle diameter”, an average particle diameter of lubricant particles corresponding to a 50% volume of all the lubricant, which is obtained by dispersing a lubricant to be used in the presence of a dispersing agent, adding water to the lubricant dispersion immediately after the dispersing to dilute to 0.5%, placing the resulting test liquid into warm water at 40° C., adjusting the light transmittance to 71±1%, ultrasound-treating this for 30 seconds, and measuring the average particle diameter by a laser diffraction particle size distribution measuring apparatus (trade name: LA910, manufactured by Horiba, Ltd), was used.

(3) Preparation of Coating Solution for Protective Layer A

Water: 321.4 g

Methanol: 181.9 g,

7.2% aqueous polyvinyl alcohol solution: 461.7 g (trade name; PVA124C, manufactured by Kuraray Co., Ltd.)

72% aqueous sodium dodecylbenzenesulfonate: 7.9 g

50% aqueous acetylene glycol surfactant solution: 8.5 g (trade name; Surfinol 104E, mariufactured by Nisshin Chemicals Co., Ltd.)

26% aqueous solution of the aforementioned exemplified compound (B-4): 44.6 g

Polyoxyethylene alkyl phosphoric acid ester: 3.0 g (trade name; PrisurfA217E, manufactured by Dai-ichi Kogyo Seiyaku Co., Ltd., melting point 35° C.)

The aforementioned pigment dispersion for protective layer: 369.2 g

The aforementioned lubricant dispersion for protective layer-1: 14.2 g

The aforementioned lubricant dispersion for protective layer-2: 28.0 g

21.0% zinc stearate dispersion: 31.9 g (trade name; Himicron L111, manufactured by Chukyo Yushi Co., Ltd.)

18% stearic acid dispersion: 35.6 g (trade name; Cellosol 920, manufactured by Chukyo Yushi Co., Ltd.)

35% silicone oil water dispersion: 64.1 g (trade name; BY22-840, manufactured by Dow Corning Toray Co., Ltd.)

5% aqueous styrene-maleic acid copolymer ammonium salt solution: 169.7 g (trade name; Polymalon 385, manufactured by Arakawa Chemical Industries, Ltd.)

20% colloidal silica: 81.7 g (trade name; Snowtex O, manufactured by Nissan Chemical Industries, Ltd.)

Boric acid: 6.6 g

99.7% aqueous acetic acid solution: 0.4 g

Compound represented by the structural formula [403] (50% aqueous solution): 23.4 g

Compound represented by the following structural formula [404]: 1.9 g were mixed, and water was added thereto to adjust to a concentration of 12%, whereby an objective coating solution A for a protective layer was obtained.

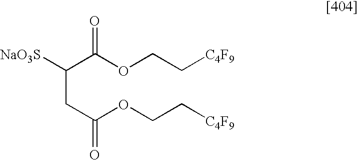

According to the same manner as that of Example 1 except that the coating solution for a protective layer was changed to the aforementioned coating solution A for a protective layer in Example 1, a heat-sensitive recording material was manufactured, and evaluation was performed as in Example 1. The results are shown in Table 1.

### Example 9

According to the same manner as that of Example 8 except that the aforementioned exemplified compound (A-08) used for preparing a lubricant dispersion for a protective layer-2 was replaced with the same amount of the aforementioned exemplified compound (A-32) in Example 8, a heat-sensitive recording material was manufactured, and evaluation was performed as in Example 8. Results are shown in Table 1.

### Example 10

According to the same manner as that of Example 8 except that the aforementioned exemplified compound (A-08) used for preparing a lubricant dispersion for a protective layer-2 was replaced with the same amount of the aforementioned exemplified compound (A-26) in Example 8, a heat-sensitive recording material was manufactured, and evaluation was performed as in Example 8. Results are shown in Table 1.

TABLE 1

| | | Evaluation results | | | | | |
|---|---|---|---|---|---|---|---|
| | | | | | Torque (kg · cm) | | |
| | Compound represented by | | | | classified by energy | | |
| | any of formulas (1) to (3) to | Surface | | | (mJ/mm²) | | |
| | be used | roughening | Sticking | Whitening | 35 | 60 | 90 |
| Example 1 | B-1 | A | A | B | 3.5 | 3.0 | 2.4 |
| Example 2 | B-4 | A | A | B | 2.8 | 2.1 | 1.4 |
| Example 3 | B-5 | B | A | B | 2.7 | 2.0 | 1.4 |
| Example 4 | B-2 | B | A | B | 3.7 | 3.1 | 2.5 |
| Example 5 | B-6 | B | A | B | 3.2 | 2.2 | 1.9 |
| Example 6 | B-7 | B | A | B | 3.1 | 2.1 | 1.8 |
| Example 7 | B-4 | A | A | B | 2.8 | 2.0 | 1.4 |
| Example 8 | A-08, B-4 | B | A | B | 2.5 | 1.7 | 1.1 |
| Example 9 | A-32, B-4 | B | A | C | 2.1 | 1.2 | 0.8 |
| Example 10 | A-26, B-4 | B | A | A | 2.9 | 1.9 | 1.1 |
| Comparative | — | D | A | C | 3.5 | 3.0 | 3.4 |
| Example 1 | | | | | | | |
| Comparative | — | B | C | B | 3.6 | 3.7 | 2.6 |
| Example 2 | | | | | | | |
| Comparative | — | D | A | C | 3.4 | 2.9 | 3.3 |
| Example 3 | | | | | | | |
| Comparative | — | C-D | B | C | 3.9 | 3.0 | 3.2 |
| Example 4 | | | | | | | |
| Comparative | — | C-D | B | C | 4.2 | 2.8 | 3.4 |
| Example 5 | | | | | | | |

From the results of Table 1, it was seen that heat-sensitive recording materials not generating surface roughening, whitening or sticking are obtained in Examples 1 to 10, and further, the conveying torque is low in Examples 8 to 10. On the other hand, it was seen that there are practical problems in Comparative Examples.

The present invention provides at least the following embodiments 1 to 20.

1. A heat-sensitive recording material comprising at least a heat-sensitive recording layer on a support, wherein the material contains at least a betaine compound represented by the following formula (1):

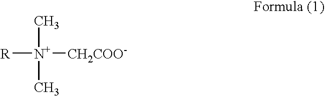

wherein R represents an alkyl group which may have a substituent.

2. The heat-sensitive recording material according to embodiment 1, further comprising a protective layer, wherein the protective layer contains at least one of the betaine compound represented by the formula (1), a compound represented by the following formula (2) and a compound represented by the following formula (3):

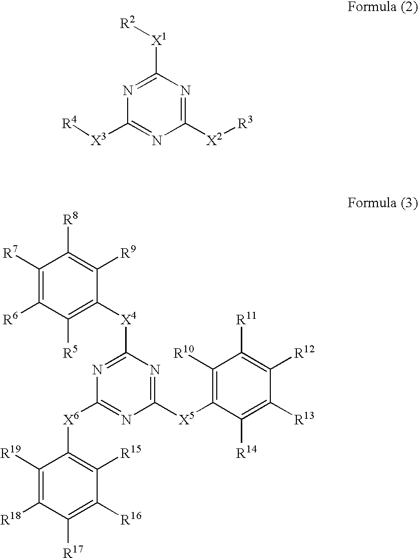

wherein X¹ to X⁶ each independently represent NR¹, S or O; R¹ represents a hydrogen atom, an alkyl group, an aryl group, an acyl group, an alkoxycarbonyl group, an aryloxycarbonyl group or a carbamoyl group; R², R³ and R⁴ each independently represent a hydrogen atom, an alkyl group or a heterocyclic group and when R¹ and at least two of R², R³ and R⁴ are other than a hydrogen atom, they may be bound to each other to form a ring; and R⁵ to R¹⁹ each independently represent a hydrogen atom, an alkyl group, an aryl group, an alkoxy group, an aryloxy group, an alkylthio group, an arylthio group, an acyloxy group, an acylamino group, an alkoxycarbonyl group, an aryloxycarbonyl group, a carbamoyl group, a sulfamoyl group or a halogen atom and when at least two of R⁵ to R¹⁹ are other than a hydrogen atom, they may be bound to each other to form a ring.

3. The heat-sensitive recording material according to embodiment 1, wherein the betaine compound represented by the formula (1) is a betaine compound represented by the following formula (4):

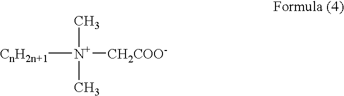

wherein n represents an integer of 1 to 24.

4. The heat-sensitive recording material according to embodiment 3, wherein n in the formula (4) represents an integer of 8 to 22.

5. The heat-sensitive recording material according to embodiment 2, wherein the protective layer further contains at least one of a lubricant which is a liquid at ambient temperature or a heat-meltable lubricant.

6. The heat-sensitive recording material according to embodiment 2, wherein the protective layer further contains at least three heat-meltable lubricants having different melting points.

7. The heat-sensitive recording material according to embodiment 2, wherein the protective layer further contains a pigment.

8. The heat-sensitive recording material according to embodiment 7, wherein the 50% volume average particle diameter of the pigment is 0.10 to 5.0 μm.

9. The heat-sensitive recording material according to embodiment 2, wherein the protective layer further contains a water-soluble resin and a crosslinking agent which crosslinks the water-soluble resin.

10. The heat-sensitive recording material according to embodiment 1, wherein the support is a transparent film.

11. The heat-sensitive recording,material according to embodiment 2, wherein the protective layer is an uppermost layer.

12. A heat-sensitive recording material comprising at least a heat-sensitive recording layer on a support, wherein the material contains a betaine compound represented by the following formula (1), and at least one of a compound represented by the following formula (2) or a compound represented by the following formula (3):

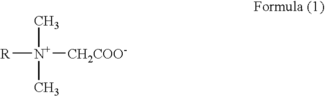

wherein R represents an alkyl group which may have a substituent,

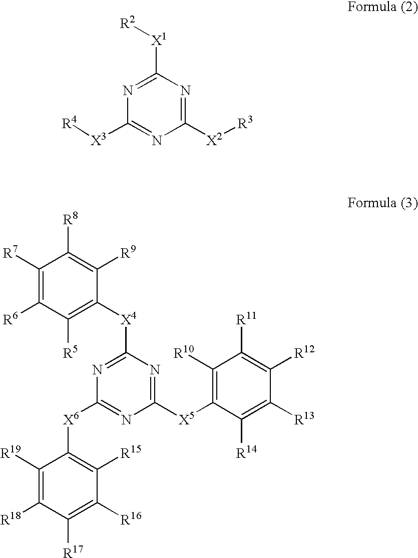

and wherein X¹ to X⁶ each independently represent NR¹, S or O; R¹ represents a hydrogen atom, an alkyl group, an aryl group, an acyl group, an alkoxycarbonyl group, an aryloxycarbonyl group or a carbamoyl group; R², R³ and R⁴ each independently represent a hydrogen atom, an alkyl group or a heterocyclic group and when R¹ and at least two of R², R³ and R⁴ are other than a hydrogen atom, they may be bound to each other to form a ring; and R⁵ to R¹⁹ each independently represent a hydrogen atom, an alkyl group, an aryl group, an alkoxy group, an aryloxy group, an alkylthio group, an arylthio group, an acyloxy group, an acylamino group, an alkoxycarbonyl group, an aryloxycarbonyl group, a carbamoyl group, a sulfamoyl group or a halogen atom and when at least two of R⁵ to R¹⁹ are other than a hydrogen atom, they may be bound to each other to form a ring.

13. The heat-sensitive recording material according to embodiment 12, wherein the material contains the betaine compound represented by the formula (1), and at least one of the compound represented by the formula (2) or the compound represented by the formula (3), in the same layer.

14. The heat-sensitive recording material according to embodiment 12, wherein in the compound represented by the formula (2) and the compound represented by the formula (3), at least one of X¹ to X³ and at least one of X⁴ to X⁶ are S, O or NH.

15. The heat-sensitive recording material according to embodiment 12, wherein in the compound represented by the formula (2) R², R³ and R⁴ are each independently a group having a total carbon number of 8 or more.

16. The heat-sensitive recording material according to embodiment 12, wherein in the compound represented by the formula (3) R⁵ to R¹⁹ are each independently a group having a carbon number of 4 or more.

17. A heat-sensitive recording material comprising at least a heat-sensitive recording layer on a support, wherein the material contains at least a betaine compound represented by the following formula (5):

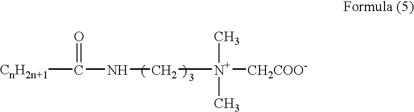

wherein n represents an integer of 1 to 24.

18. A heat-sensitive recording method comprising applying thermal energy to the heat-sensitive recording material as defined in embodiment 1 by using a thermal head which includes a layer having a carbon ratio of 90% by mass or more as an uppermost layer.

19. A heat-sensitive recording method comprising applying thermal energy to the heat-sensitive recording material as defined in embodiment 12 by using a thermal head which includes a layer having a carbon ratio of 90% by mass or more as an uppermost layer.

20. A heat-sensitive recording method comprising applying thermal energy to the heat-sensitive recording material as defined in embodiment 17 by using a thermal head which includes a layer having a carbon ratio of 90% by mass or more as an uppermost layer.

Therefore, according to the invention, a heat-sensitive recording material which prevents surface roughening and sticking and is excellent in head matching all over the wide recording energy region, particularly in a high recording energy region, and a heat-sensitive recording method using this can be provided.

What is claimed is:

1. A heat-sensitive recording material comprising at least a heat-sensitive recording layer on a support, wherein the material contains at least a betaine compound represented by the following formula (1): 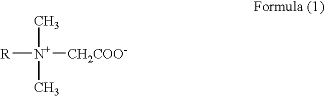
wherein R represents an alkyl group which may have a substituent.

2. The heat-sensitive recording material according to claim 1, further comprising a protective layer, wherein the protective layer contains at least one of the betaine compound represented by the formula (1), a compound represented by the following formula (2) and a compound represented by the following formula (3): 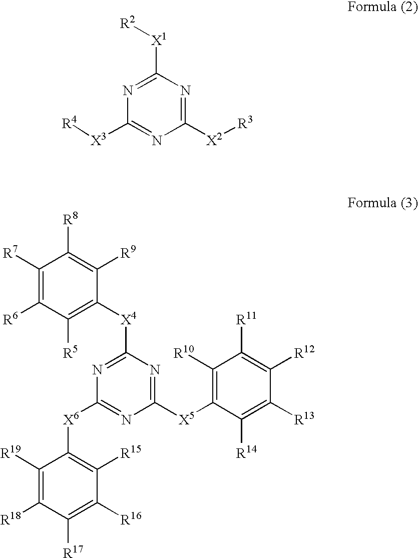
wherein X¹ to X⁶ each independently represent NR¹, S or O; R¹ represents a hydrogen atom, an alkyl group, an aryl group, an acyl group, an alkoxycarbonyl group, an aryloxycarbonyl group or a carbamoyl group; R², R³ and R⁴ each independently represent a hydrogen atom, an alkyl group or a heterocyclic group and when R¹ and at least two of R², R³ and R⁴ are other than a hydrogen atom, they may be bound to each other to form a ring; and R⁵ to R¹⁹ each independently represent a hydrogen atom, an alkyl group, an aryl group, an alkoxy group, an aryloxy group, an alkylthio group, an arylthio group, an acyloxy group, an acylamino group, an alkoxycarbonyl group, an aryloxycarbonyl group, a carbamoyl group, a sulfamoyl group or a halogen atom and when at least two of R⁵ to R¹⁹ are other than a hydrogen atom, they may be bound to each other to form a ring.

3. The heat-sensitive recording material according to claim 1, wherein the betaine compound represented by the formula (1) is a betaine compound represented by the following formula (4): 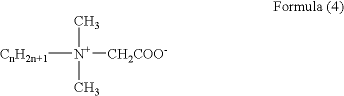
wherein n represents an integer of 1 to 24.

4. The heat-sensitive recording material according to claim 3, wherein n in the formula (4) represents an integer of 8 to 22.

5. The heat-sensitive recording material according to claim 2, wherein the protective layer further contains at least one of a lubricant which is a liquid at ambient temperature or a heat-meltable lubricant.

6. The heat-sensitive recording material according to claim 2, wherein the protective layer further contains at least three heat-meltable lubricants having different melting points.

7. The heat-sensitive recording material according to claim 2, wherein the protective layer further contains a pigment.

8. The heat-sensitive recording material according to claim 7, wherein the 50% volume average particle diameter of the pigrnent is 0.10 to 5.0 μm.

9. The heat-sensitive recording material according to claim 2, wherein the protective layer further contains a water-soluble resin and a crosslinking agent which crosslinks the water-soluble resin.

10. The heat-sensitive recording material according to claim 1, wherein the support is a transparent film.

11. The heat-sensitive recording material according to claim 2, wherein the protective layer is an uppermost layer.

12. A heat-sensitive recording material comprising at least a heat-sensitive recording layer on a support, wherein the material contains a betaine compound represented by the following formula (1), and at least one of a compound represented by the following formula (2) or a compound represented by the following formula (3): 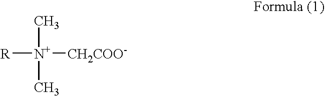
wherein R represents an alkyl group which may have a substituent, 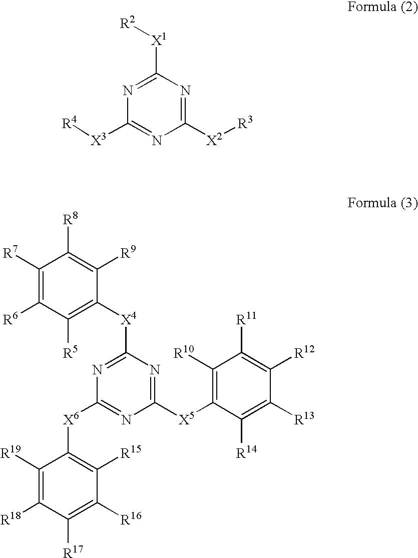
and wherein X¹ to X⁶ each independently represent NR¹, S or O; R¹ represents a hydrogen atom, an alkyl group, an aryl group, an acyl group, an alkoxycarbonyl group, an aryloxycarbonyl group or a carbamoyl group; R², R³ and R⁴ each independently represent a hydrogen atom, an alkyl group or a heterocyclic group and when R¹ and at least two of R², R³ and R⁴ are other than a hydrogen atom, they may be bound to each other to form a ring; and R⁵ to R¹⁹ each independently represent a hydrogen atom, an alkyl group, an aryl group, an alkoxy group, an aryloxy group, an alkylthio group, an arylthio group, an acyloxy group, an acylamino group, an alkoxycarbonyl group, an aryloxycarbonyl group, a carbamoyl group, a sulfamoyl group or a halogen atom and when at least two of R⁵ to R¹⁹ are other than a hydrogen atom, they may be bound to each other to form a ring.

13. The heat-sensitive recording material according to claim 12, wherein the material contains the betaine compound represented by the formula (1), and at least one of the compound represented by the formula (2) or the compound represented by the formula (3), in the same layer.

14. The heat-sensitive recording material according to claim 12, wherein in the compound represented by the formula (2) and the compound represented by the formula (3), at least one of X¹ to X³ and at least one of X⁴ to X⁶ are S, 0 or NH.

15. The heat-sensitive recording material according to claim 12, wherein in the compound represented by the formula (2) R², R³ and R⁴ are each independently a group having a total carbon number of 8 or more.

16. The heat-sensitive recording material according to claim 12, wherein in the compound represented by the formula (3) R⁵ to R¹⁹ are each independently a group having a carbon number of 4 or more.

17. A heat-sensitive recording material comprising at least a heat-sensitive recording layer on a support, wherein the material contains at least a betaine compound represented by the following formula (5): 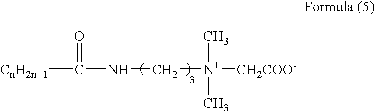
wherein n represents an integer of 1 to 24.

18. A heat-sensitive recording method comprising applying thermal energy to the heat-sensitive recording material as defined in claim 1 by using a thermal head which includes a layer having a carbon ratio of 90% by mass or more as an uppermost layer.

19. A heat-sensitive recording method comprising applying thermal energy to the heat-sensitive recording material as defined in claim 12 by using a thermal head which includes a layer having a carbon ratio of 90% by mass or more as an uppermost layer.

20. A heat-sensitive recording method comprising applying thermal energy to the heat-sensitive recording material as defined in claim 17 by using a thermal head which includes a layer having a carbon ratio of 90% by mass or more as an uppermost layer.
